(19) United States
(12) Patent Application Publication
(10) Pub. No.: US 2018/0063399 A1
(43) Pub. Date: Mar. 1, 2018

(54) IMAGE PROCESSING APPARATUS AND METHOD, IMAGE CAPTURING APPARATUS, AND STORAGE MEDIUM

(71) Applicant: CANON KABUSHIKI KAISHA, Tokyo (JP)

(72) Inventor: Ichiro Matsuyama, Kawasaki-shi (JP)

(21) Appl. No.: 15/674,597

(22) Filed: Aug. 11, 2017

(30) Foreign Application Priority Data
Aug. 26, 2016 (JP) 2016-166008

(51) Int. Cl. H04N 5/232; H04N 5/345

(52) U.S. Cl. CPC H04N 5/2327; H04N 5/2329; H04N 5/23258; H04N 5/345

(57) ABSTRACT

An image processing apparatus comprises: an input unit that inputs an image signal from an image sensor, the image sensor being capable of carrying out first readout control, in which each line in a first region is read out at a first timing, and second readout control, in which each line in a second region is read out at a second timing different from the first timing; an acquisition unit that acquires a shake amount from a shake detection unit at the first timing and the second timing; and a correction unit that corrects distortion in the image signal caused by the shake amount. The correction unit changes a correction amount used in the correction on the basis of a difference between the first timing and the second timing.

### BACKGROUND OF THE INVENTION

### Field of the Invention

The invention relates to an image processing apparatus and method, an image capturing apparatus, and a storage medium, and particularly relates to an image processing apparatus and method, an image capturing apparatus, and a storage medium that correct distortion in a captured image that depends on the timing of charge readout from an image sensor.

### Description of the Related Art

Conventionally, in CMOS image sensors used in image capturing apparatuses, accumulated charges are read out line by line from the top to the bottom of the image sensor, in what is known as the “rolling shutter” (RS) method. In RS readout, the timing of the readout differs between the top and the bottom of the image sensor. Thus in the case where the image capturing apparatus shakes and the position of the subject moves in the image capturing plane, distortion will arise in the captured image due to the difference in the timings of the charge readout from the image sensor (called “RS distortion”).

As a method for correcting such RS distortion, Japanese Patent Laid-Open No. 2014-64143 proposes a method in which an amount of shake arising in an image capturing apparatus is discretely obtained in synchronization with the timing of readout from a CMOS image sensor, and RS distortion is corrected on the basis of the obtained shake amount.

Meanwhile, image capturing apparatuses that carry out focus detection through what is known as an “on-imaging plane phase difference detection method”, using focus detection pixels formed in the image sensor, have appeared in recent years. In the image sensor disclosed in Japanese Patent Laid-Open No. 2013-110607, each pixel includes one microlens and two photodiodes, such that each photodiode receives light passing through different pupil regions of an imaging lens. Focus detection can be carried out by comparing charge signals accumulated in the two photodiodes, and a captured image can be generated by adding together and reading out the charge signals from the two photodiodes. However, reading out the charge signals from the two photodiodes for all regions greatly increases the readout time. Limiting the regions in which focus detection is carried out, and adding together the charges from the two photodiodes in the image sensor before the readout and then reading out those charges for the other regions, is disclosed as a way of suppressing the increase in readout time.

However, with the method of readout from the image sensor disclosed in Japanese Patent Laid-Open No. 2013-110607, the regions in which the output signals from the two photodiodes are read out individually have double the readout time as the regions in which the output signals are read out after adding the charges together. The amount of RS distortion in the captured image relative to the shake in the image capturing apparatus will therefore differ depending on the region.

Conventional methods of correcting RS distortion, such as that disclosed in Japanese Patent Laid-Open No. 2014-64143, do not specifically describe methods for correcting captured images in which the length of the readout time differs from region to region of the image sensor. Problems such as the following have thus arisen.

For example, as illustrated in FIG. 27, assume that shake having a constant speed in the horizontal direction is imparted on an image capturing apparatus held horizontally while capturing an image of a subject 2700. FIGS. 28A and 28B are diagrams illustrating an effect of RS distortion correction on the image data captured in this manner.

In the case where the readout time is constant throughout all the regions of the image sensor, image data in which the subject 2700 is uniformly distorted in the diagonal direction will be obtained, as indicated by 2800 in FIG. 28A. 2801 indicates angle data calculated by discretely obtaining an amount of shake arising in the image capturing apparatus along the time axis, and an RS distortion correction amount, indicated by 2802, is found from that data. Here, 2801 and 2802 indicate the angle data and RS distortion correction amount relative to a rotation component of the image capturing apparatus in the horizontal direction. A readout range 2803 of image data 2800 is then determined on the basis of the RS distortion correction amount that has been found, and the RS distortion is then corrected by reshaping and outputting the readout range 2803. 2804 indicates the post-RS distortion correction output image, in which the distortion that had arisen in the subject 2700 is corrected.

On the other hand, in the case where the readout time for each line is longer in some regions of the image sensor than in other regions, image data in which the distortion in one part of the subject 2700 is different from other parts is obtained, as indicated by 2810 in FIG. 28B. Here, it is assumed that the readout time for each line in a region 2811 is double that in other regions. If the same RS distortion correction as that illustrated in FIG. 28A is carried out on the image data 2810, a post-RS distortion correction output image such as that indicated by 2814 will be obtained. In the output image 2814, the distortion that had arisen in the subject 2700 has not been sufficiently corrected, and thus some distortion remains.

### SUMMARY OF THE INVENTION

The present invention has been made in consideration of the above situation, and properly corrects rolling shutter distortion in captured image data even if the readout time for each of lines is longer in some regions of an image sensor.

According to the present invention, provided is an image processing apparatus comprising: an input unit that inputs an image signal from an image sensor, which accumulates a charge converted from received light of a subject image formed by an imaging optical system at a timing depending on a respective line, the image sensor being capable of carrying out first readout control, in which each line in a first region is read out at a first timing, and second readout control, in which each line in a second region different from the first region is read out at a second timing different from the first timing; an acquisition unit that acquires a shake amount from a shake detection unit at the first timing and the second timing; and a correction unit that corrects distortion in the image signal caused by the shake amount, the correction unit changing a correction amount used in the correction on the basis of a difference between the first timing and the second timing.

Further, according to the present invention, provided is an image processing apparatus comprising: an input unit that inputs an image signal from an image sensor, which accumulates a charge converted from received light of a subject image formed by an imaging optical system at a timing depending on a respective line, the image sensor being capable of carrying out first readout control, in which each line in a first region is read out in a predetermined first time, and second readout control, in which each line in a second region different from the first region is read out in a second time different from the first time; a memory that stores the image signal acquired from the image sensor; an acquisition unit that acquires a shake amount from a shake detection unit; a controller that assigns the second region to the image sensor; a calculation unit that finds, on the basis of the shake amount acquired by the acquisition unit, a distortion correction amount for correcting distortion in an image expressed by the image signal, the distortion being caused by shake while the image sensor accumulates a charge; and a correction unit that corrects the distortion and outputs an image by correcting a readout position of the image signal recorded in the memory on the basis of the distortion correction amount and the position of the second region.

Furthermore, according to the present invention, provided is an image capturing apparatus comprising: the image sensor; and the image processing apparatus comprising: an input unit that inputs an image signal from an image sensor, which accumulates a charge converted from received light of a subject image formed by an imaging optical system at a timing depending on a respective line, the image sensor being capable of carrying out first readout control, in which each line in a first region is read out at a first timing, and second readout control, in which each line in a second region different from the first region is read out at a second timing different from the first timing; an acquisition unit that acquires a shake amount from a shake detection unit at the first timing and the second timing; and a correction unit that corrects distortion in the image signal caused by the shake amount, the correction unit changing a correction amount used in the correction on the basis of a difference between the first timing and the second timing.

Further, according to the present invention, provided is an image processing method comprising: inputting an image signal from an image sensor, which accumulates a charge converted from received light of a subject image formed by an imaging optical system at a timing depending on a respective line, the image sensor being capable of carrying out control in which each line in a first region is read out in a predetermined first time, and control in which each line in a second region different from the first region is read out in a second time different from the first time; storing the image signal acquired from the image sensor in a memory; acquiring a shake amount from a shake detection unit; assigning the second region to the image sensor; finding, on the basis of the shake amount acquired in the step of acquiring, a position of the second region assigned in the step of assigning, and a ratio of the first time to the second time, a distortion correction amount for correcting distortion in an image expressed by the image signal, the distortion being caused by shake while the image sensor accumulates a charge, and changing the distortion in the image caused by a difference between the first time and the second time; and correcting the image signal stored in the memory on the basis of the distortion correction amount.

Further, according to the present invention, provided is an image processing method comprising: inputting an image signal from an image sensor, which accumulates a charge converted from received light of a subject image formed by an imaging optical system at a timing depending on a respective line, the image sensor being capable of carrying out control in which each line in a first region is read out in a predetermined first time, and control in which each line in a second region different from the first region is read out in a second time different from the first time; storing the image signal acquired from the image sensor in a memory; acquiring a shake amount from a shake detection unit; assigning the second region to the image sensor; finding, on the basis of the acquired shake amount, a distortion correction amount for correcting distortion in an image expressed by the image signal, the distortion being caused by shake while the image sensor accumulates a charge; and correcting the distortion and outputting an image by correcting a readout position of the image signal recorded in the memory on the basis of the distortion correction amount and the position of the second region.

Further, according to the present invention, provided is a non-transitory computer-readable storage medium storing a program that causes a computer to function as the respective units of the image processing apparatus comprising: an input unit that inputs an image signal from an image sensor, which accumulates a charge converted from received light of a subject image formed by an imaging optical system at a timing depending on a respective line, the image sensor being capable of carrying out first readout control, in which each line in a first region is read out at a first timing, and second readout control, in which each line in a second region different from the first region is read out at a second timing different from the first timing; an acquisition unit that acquires a shake amount from a shake detection unit at the first timing and the second timing; and a correction unit that corrects distortion in the image signal caused by the shake amount, the correction unit changing a correction amount used in the correction on the basis of a difference between the first timing and the second timing.

Further, according to the present invention, provided is a non-transitory computer-readable storage medium storing a program that causes a computer to function as the respective units of the image processing apparatus comprising: an input unit that inputs an image signal from an image sensor, which accumulates a charge converted from received light of a subject image formed by an imaging optical system at a timing depending on a respective line, the image sensor being capable of carrying out first readout control, in which each line in a first region is read out in a predetermined first time, and second readout control, in which each line in a second region different from the first region is read out in a second time different from the first time; a memory that stores the image signal acquired from the image sensor; an acquisition unit that acquires a shake amount from a shake detection unit; a controller that assigns the second region to the image sensor; a calculation unit that finds, on the basis of the shake amount acquired by the acquisition unit, a distortion correction amount for correcting distortion in an image expressed by the image signal, the distortion being caused by shake while the image sensor accumulates a charge; and a correction unit that corrects the distortion and outputs an image by correcting a readout position of the image signal recorded in the memory on the basis of the distortion correction amount and the position of the second region.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram illustrating a configuration of an image capturing apparatus according to a first embodiment of the invention.

FIG. 2 is an equivalent circuit diagram illustrating a unit pixel in an image sensor.

FIGS. 3A to 3D are schematic diagrams illustrating details of RS distortion correction processing carried out by an RS distortion correction unit in yaw, pitch, and roll directions according to the first embodiment.

FIGS. 4A and 4B are diagrams illustrating an example of image data read out from the image sensor and image data stored in an image memory according to the first embodiment.

FIGS. 5A and 5B are conceptual diagrams illustrating details of processing carried out by an RS distortion correction amount computation unit according to the first embodiment.

FIG. 6 is a timing chart illustrating an operation sequence of the image capturing apparatus according to the first embodiment.

FIG. 7 is a flowchart illustrating details of processing carried out by a control microcomputer according to the first embodiment.

FIGS. 8A and 8B are flowcharts illustrating details of processing carried out by the RS distortion correction amount computation unit according to the first embodiment.

FIGS. 9A to 9C are diagrams illustrating an example of image data read out from an image sensor and image data stored in an image memory according to a second embodiment.

FIGS. 10A and 10B are schematic diagrams illustrating details of processing carried out by an RS distortion correction amount computation unit according to the second embodiment.

FIGS. 11A and 11B are diagrams illustrating an example of image data read out from an image sensor and image data stored in an image memory according to a third embodiment.

FIGS. 12A and 12B are conceptual diagrams illustrating details of processing carried out by an RS distortion correction amount computation unit according to the third embodiment.

FIGS. 13A and 13B are schematic diagrams illustrating details of processing carried out by an RS distortion correction amount computation unit according to a fourth embodiment.

FIGS. 14A and 14B are schematic diagrams illustrating details of processing carried out by an RS distortion correction amount computation unit according to a fifth embodiment.

FIGS. 15A and 15B are conceptual diagrams illustrating details of processing carried out by an RS distortion correction amount computation unit according to a sixth embodiment.

FIG. 16 is a flowchart illustrating details of processing carried out by a control microcomputer according to the sixth embodiment.

FIG. 17 is a flowchart illustrating details of processing carried out by the RS distortion correction amount computation unit according to the sixth embodiment.

FIGS. 18A and 18B are conceptual diagrams illustrating details of processing carried out by an RS distortion correction amount computation unit according to a seventh embodiment.

FIG. 19 is a flowchart illustrating details of processing for assigning lines in which an RS distortion correction amount is set, carried out by a control microcomputer, according to the seventh embodiment.

FIG. 20 is a block diagram illustrating the configuration of an image capturing apparatus according to an eighth embodiment.

FIG. 21 is a conceptual diagram illustrating details of processing carried out by an angle data generation unit and a control microcomputer according to the eighth embodiment.

FIG. 22 is a block diagram illustrating the configuration of an RS distortion correction unit according to the eighth embodiment.

FIGS. 23A to 23D are schematic diagrams illustrating coordinate conversion carried out by a coordinate conversion unit according to the eighth embodiment.

FIGS. 24A to 24D are schematic diagrams illustrating details of RS distortion correction processing carried out by an RS distortion coordinate conversion unit in yaw, pitch, and roll directions according to the eighth embodiment.

FIG. 25 is a flowchart illustrating details of processing carried out by the control microcomputer according to the eighth embodiment.

FIG. 26 is a diagram illustrating an example of image data read out from an image sensor and image data stored in an image memory according to a tenth embodiment.

FIG. 27 is a diagram illustrating shake imparted on an image capturing apparatus while a subject is being captured.

FIGS. 28A and 28B are schematic diagrams illustrating examples of conventional RS distortion correction.

### DESCRIPTION OF THE EMBODIMENTS

Exemplary embodiments of the present invention will be described in detail in accordance with the accompanying drawings.

### First Embodiment

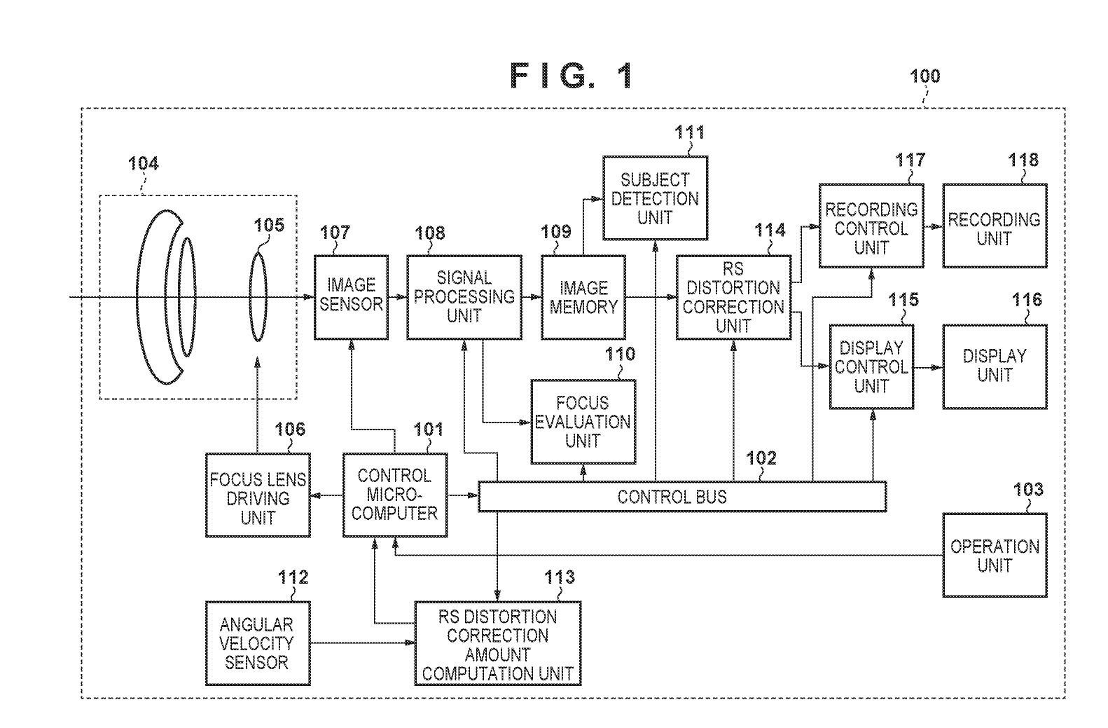

FIG. 1 is a block diagram illustrating the configuration of an image capturing apparatus 100 according to a first embodiment of the invention. A control microcomputer 101 includes a non-volatile memory and a work memory (not illustrated), and controls the various blocks connected directly or by a control bus 102 on the basis of programs and data stored in the non-volatile memory while temporarily writing data into the work memory.

An operation unit 103 is constituted of a shutter button, a focus ring, a touch panel, and the like provided in parts of an external housing of the image capturing apparatus 100, and communicates user operations to the control microcomputer 101.

An imaging optical system 104 forms a subject image on an imaging surface of an image sensor 107 via an optical system such as a focus lens 105. An aperture, a zoom lens, a shift lens, a mechanical shutter, and an optical low-pass filter (not illustrated) are also provided. A focus lens driving unit 106 moves the focus lens 105 forward and backward in an optical axis direction on the basis of instructions from the control microcomputer 101 to adjust the focus of the imaging optical system 104. Note that driving units (not illustrated) that drive the aperture, the zoom lens, the shift lens, and the mechanical shutter of the imaging optical system 104 on the basis of instructions from the control microcomputer 101 may also be provided.

The image sensor 107 generates an image signal by photoelectrically converting the subject image formed on the imaging surface, and outputs image data obtained by A/D converting the image signal. It is assumed here that the image sensor 107 is a Bayer array-type CMOS image sensor in which a plurality of unit pixels are arranged in a matrix. Sub-pixels a and b are provided in each unit pixel, and a photodiode (“PD” hereinafter) serving as a photoelectric conversion unit is disposed in each of the sub-pixels a and b. Output signals output from the sub-pixels a and b (an a signal and a b signal) are used in focus detection, whereas an a/b combined signal obtained by adding the two is used in image generation. The configuration of the unit pixels in the image sensor 107 and a method for reading out the output signals will be described later.

A signal processing unit 108 carries out a correction process, a developing process, and so on on the image data output from the image sensor 107, stores the image data of the a/b combined signal in an image memory 109, and outputs image data of the a signal and the b signal to a focus evaluation unit 110. The first embodiment assumes that the image data of the b signal is obtained by the signal processing unit 108 subtracting the a signal from the a/b combined signal, for each of the unit pixels from which the a signal and a/b combined signal image data have been read out from the image sensor 107. Note that control may be carried out such that the image data of the a signal and the b signal are both read out from the image sensor 107 and added together by the signal processing unit 108 to obtain the image data of the a/b combined signal.

The focus evaluation unit 110 calculates a defocus amount of the subject image from a phase difference between the image data of the a signal and the image data of the b signal output from the signal processing unit 108.

A subject detection unit 111 detects the position and size of a subject such as a person from the image data stored in the image memory 109, and communicates that information to the control microcomputer 101.

An angular velocity sensor 112 detects shake imparted on the image capturing apparatus 100 as an angular velocity signal and outputs the angular velocity signal. Here, assuming that the optical axis direction corresponds to a Z axis, an upward-vertical direction corresponds to a Y axis, and a direction orthogonal to both the Y and Z axis directions corresponds to an X axis, the angular velocity sensor 112 detects angular shake in a yaw direction (around the Y axis), a pitch direction (around the X axis), and a roll direction (around the Z axis).

An RS distortion correction amount computation unit 113 A/D-converts the angular velocity signals output from the angular velocity sensor 112, integrates angular velocity data obtained as a result, and generates yaw direction, pitch direction, and roll direction angle data at each of timings based on instructions from the control microcomputer 101. An RS distortion correction amount is then calculated from the generated angle data for each timing, and the RS distortion correction amount is communicated to the control microcomputer 101. Specific details of the processing carried out by the RS distortion correction amount computation unit 113 will be given later.

An RS distortion correction unit 114 corrects the RS distortion by reshaping the image data in the image memory 109 on the basis of an RS distortion correction amount set by the control microcomputer 101, and then outputs the corrected data. Details of the RS distortion correction process will be given later.

A display control unit 115 outputs and displays, in a display unit 116, the image data output from the RS distortion correction unit 114, on the basis of settings from the control microcomputer 101. A recording control unit 117 outputs and records, in a recording unit 118, the image data output from the RS distortion correction unit 114, on the basis of settings from the control microcomputer 101.

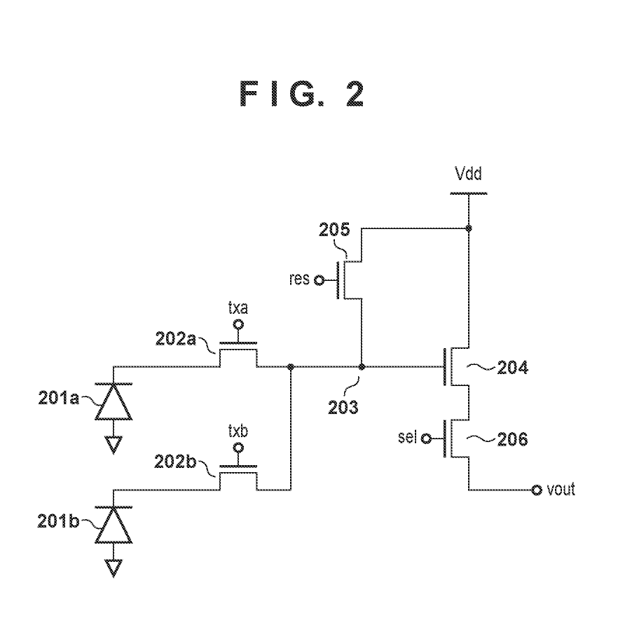

The configuration of the unit pixels in the image sensor 107 and a method for reading out the output signals will be described next using FIG. 2. Japanese Patent Laid-Open No. 2013-110607 describes in detail the same type of image sensor in which each unit pixel includes a single microlens and two photodiodes, and is capable of focus detection, as that used in the first embodiment, and thus only parts that affect the time for readout will be briefly described here.

Optical signals entering photodiodes (PDs) 201a and 201b of the aforementioned sub-pixels a and b are photoelectrically converted, and charges based on exposure amounts thereof are accumulated. Upon signals txa and txb applied to transfer gates 202a and 202b, respectively, going to high level, the charges accumulated in the PDs 201a and 201b are transferred to a floating diffusion (FD) unit 203. The FD unit 203 is connected to the gate of a source follower (SF) amp 204, and the charge amounts transferred from the PD 201a and the PD 201b are transformed into voltage amounts by the SF amp 204. Upon a signal sel applied to the gate of a pixel selection switch 206 going to high level, the pixel signal converted into a voltage by the SF amp 204 is output to an output terminal vout of the unit pixel.

Meanwhile, before the pixel signal is read out, a signal res applied to the gate of an FD reset switch 205 goes to high level to reset the FD unit 203. Also, when starting the charge accumulation, the signal res and the signals txa and txb go to high level simultaneously to reset the charges in the PDs 201a and 201b. As a result, the transfer gates 202a and 202b and the FD reset switch 205 all turn on, and the PD 201a and PD 201b are reset to a source voltage Vdd via the FD unit 203.

Each time a single frame's worth of image data is read out, the control microcomputer 101 sets a target region for focus detection in the image sensor 107, and the image sensor 107 switches the method of outputting the pixel signals depending on whether or not the unit pixels that are sequentially read out are in the target region for focus detection.

When reading out a region that is not a target of focus detection, the signals txa and txb are set to high level simultaneously so that the charges accumulated in the PD 201a and the PD 201b are combined and transferred to the FD unit 203, and the a/b combined signal is then output.

Meanwhile, when reading out a region assigned as a target for focus detection, first, the signal txa is set to high level while the signal txb remains at low level so that only the charge accumulated in the PD 201a is transferred to the FD unit 203, and the a signal of the sub-pixel a is output. Next, the signal txb is also set to high level, the charge accumulated in the PD 201b is combined with the charge accumulated in the PD 201a at the FD unit 203, and the a/b combined signal is output. In the target region for focus detection, the a signal and the a/b combined signal are output sequentially on a line-by-line basis, and thus the readout takes double the time as in the region outside the target.

Although an example in which the readout time for the target region for focus detection is double is described here, the readout time need not be double. For example, narrowing down the target region for focus detection in the horizontal direction, omitting predetermined operations, and so on makes it possible to suppress the difference in readout times between lines containing the target region for focus detection and lines not containing the target region for focus detection.

Additionally, although the image sensor 107 including two photodiodes for a single pixel is described as an example here, the invention is not limited thereto. The same issue also arises in the case where the readout from the image sensor is carried out through methods in which it takes different amounts of time to read out from each region, and thus applying the invention makes it possible to solve this issue. For example, the invention can also be applied in a case of switching between whether or not to add the pixel signals in each region with surrounding signals and read out the resulting signals, a case where the number of pixels to be added is changed, a case where the readout is carried out having thinned the signals rather than adding the signals, and so on. The invention can also be applied in the case where the bit number of the pixel data is changed from region to region. Furthermore, the invention can also be applied in an image sensor capable of non-destructive readout in which the signals are read out with the PDs retaining their charges, in a case where only some regions are read out a plurality of times.

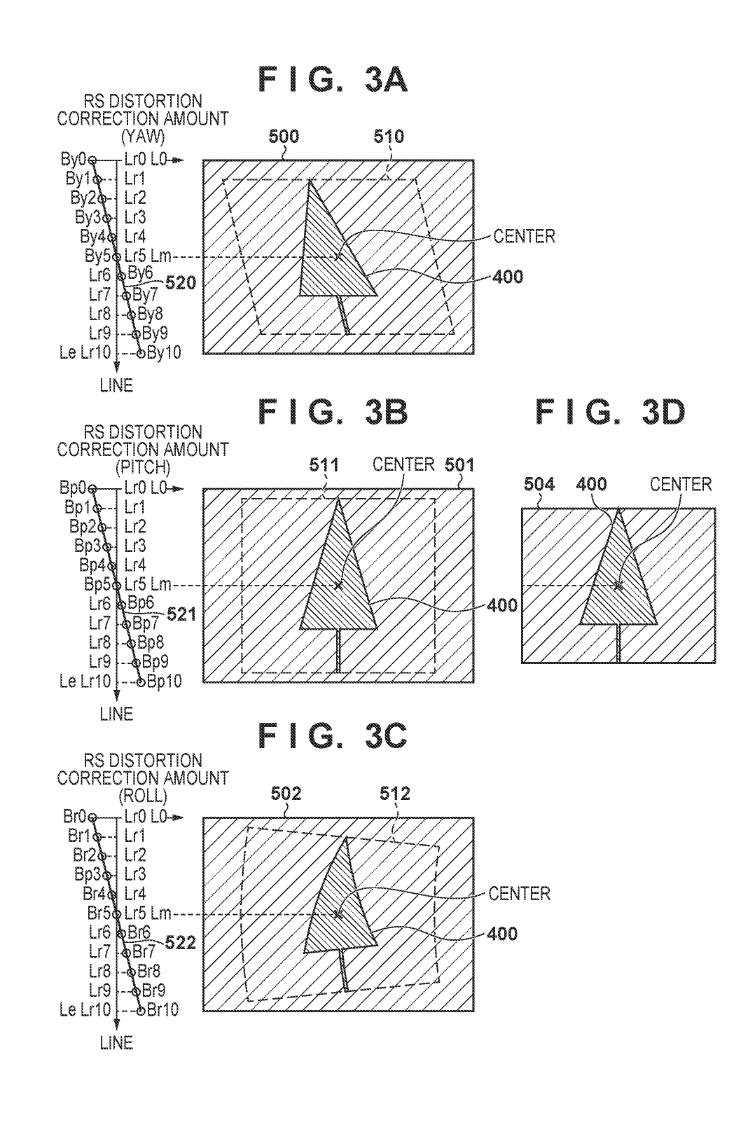

Next, the details of typical processing carried out by the RS distortion correction unit 114 will be described using FIGS. 3A to 3D. FIGS. 3A, 3B, and 3C are diagrams illustrating RS distortion correction in the yaw direction, the pitch direction, and the roll direction, respectively, whereas FIG. 3D is a diagram illustrating a correction result.

In FIG. 3A, reference numeral 500 indicates the overall range of an example of image data stored in the image memory 109. In the case where RS distortion has been produced by shake in the yaw direction imparted on the image capturing apparatus 100, a subject 400 in the image data 500 will be captured as distorted diagonally.

In the graph on the left side in FIG. 3A, the vertical axis represents each line in the image data, and the horizontal axis represents a yaw direction RS distortion correction amount. By0 to By10 indicate yaw direction RS distortion correction amounts in each of RS distortion correction amount setting target lines Lr0 to Lr10. The RS distortion correction unit 114 calculates an RS distortion correction amount 520 for all lines in the image data 500 from the discrete RS distortion correction amounts By0 to By10, using an interpolation method such as linear interpolation.

The RS distortion correction unit 114 corrects RS distortion in the horizontal direction by changing a readout start position in the horizontal direction on a line-by-line basis in accordance with the RS distortion correction amount 520, and outputting image data, of the image data 500, in a readout range 510. The readout range 510 is smaller than the image data 500 because a predetermined multiple is provided in order to ensure that the range read out through the RS distortion correction does not exceed the range of the image data. Note that in the case where angle data greater than a predetermined amount is present, the RS distortion correction amount computation unit 113 adjusts the RS distortion correction amount for all lines at a constant ratio so that the readout range of the RS distortion correction unit 114 does not exceed the range of the image data. Image data 504, indicated in FIG. 3D, is output as a result of this RS distortion correction. The correction is carried out so that the RS distortion correction amount is 0 at an intermediate line Lm, and thus the RS distortion correction amount By5 is 0 at the intermediate line Lm of Lr5, and the image data 500 and the image data 504 have the same center position.

In FIG. 3B, reference numeral 501 indicates the overall range of an example of image data stored in the image memory 109. With the subject in the image data 501, RS distortion has been produced by shake in the pitch direction imparted on the image capturing apparatus, and thus the subject is captured as distorted so as to appear stretched in the vertical direction. Depending on the direction of the shake, the subject may be captured so as to appear compressed in the vertical direction.

In the graph on the left side, the vertical axis represents each line in the image data, and the horizontal axis represents a pitch direction RS distortion correction amount. Bp0 to Bp10 indicate pitch direction RS distortion correction amounts in each of RS distortion correction amount setting target lines Lr0 to Lr10. As described above, the RS distortion correction amount computation unit 113 calculates an RS distortion correction amount 521 for all the lines in the image data 501.

The RS distortion correction unit 114 corrects RS distortion in the vertical direction by shifting a readout position in the vertical direction up or down on a line-by-line basis in accordance with the RS distortion correction amount 521, and outputting image data that takes 511 as a readout range. The image data 504, indicated in FIG. 3D, is output as a result of this RS distortion correction. The RS distortion correction amount Bp5 is 0 at the intermediate line Lm of Lr5, and thus the center position is the same in both the image data 501 and the image data 504.

In FIG. 3C, reference numeral 502 indicates the overall range of an example of image data stored in the image memory 109. With the subject in the image data 502, RS distortion has been produced by shake in the roll direction imparted on the image capturing apparatus, and thus the subject is captured as distorted into a fan shape.

In the graph on the left side, the vertical axis represents each line in the image data, and the horizontal axis represents a roll direction RS distortion correction amount. Br0 to Br10 indicate roll direction RS distortion correction amounts in each of RS distortion correction amount setting target lines Lr0 to Lr10. As described above, the RS distortion correction amount computation unit 113 calculates an RS distortion correction amount 522 for all the lines in the image data 502.

The RS distortion correction unit 114 corrects RS distortion in the roll direction by rotating a readout position of each line about a center of the image, in accordance with the RS distortion correction amount 522, and outputting image data that takes an area 512 as a readout range. The image data 504, indicated in FIG. 3D, is output as a result of this RS distortion correction. The RS distortion correction amount Br5 is 0 at the intermediate line Lm of Lr5, and thus the center position is the same in both the image data 502 and the image data 504.

RS distortion correction in the horizontal, vertical, and rotation directions have been described separately here. However, in reality, a combination of RS distortions caused by shake in the yaw, pitch, and roll directions will appear in a single piece of image data. By combining RS distortion correction amounts in the horizontal, vertical, and rotation directions for each line to be read out from the image memory 109 and calculating the readout positions, the RS distortion correction unit 114 can correct the RS distortions all at once and output the corrected image data.

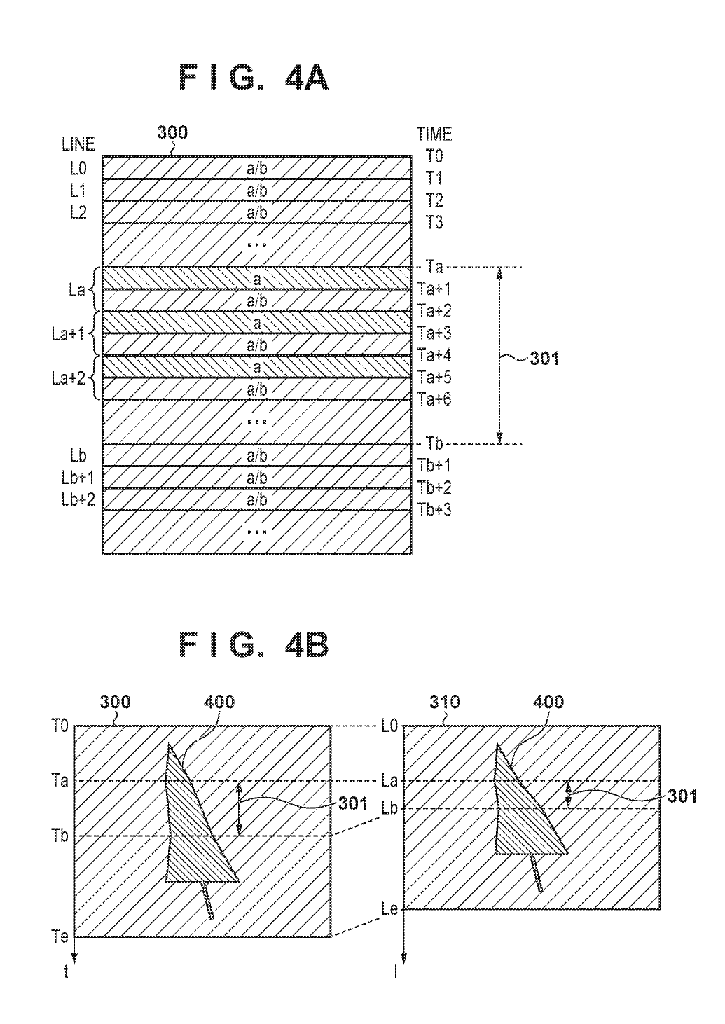

Next, image data read out from the image sensor 107 and image data stored in the image memory 109 in the case where focus detection image data is read out from a predetermined region of the image sensor 107 will be described using FIGS. 4A and 4B.

In FIG. 4A, reference numeral 300 indicates an example in which the type of the image data read out from the image sensor 107 is indicated for each line. In FIG. 4A, rectangles a/b indicate image data, in line units, corresponding to the a/b combined signal, whereas rectangles a indicate image data, in line units, corresponding to the a signal. Lines L0, L1, and L2 indicate regions outside the target of focus detection, in which only the a/b combined signal is read out, at times T0 to T1, T1 to T2, and T2 to T3, respectively. The numbers following “T” are units indicating an amount of elapsed time, and T0 to T1, T1 to T2, and T2 to T3 are assumed to be constant intervals. Meanwhile, lines La, La+1, and La+2 are within a target region for focus detection 301, in which image data corresponding to the a signal and the a/b combined signal are read out in line order, in times Ta to Ta+2, Ta+2 to Ta+4, and Ta+4 to Ta+6, respectively. Ta to Ta+2 is an interval twice as long as T0 to T1. Meanwhile, lines Lb, Lb+1, and Lb+2 indicate regions outside the target of focus detection, in which only the a/b combined signal is read out, at times Tb to Tb+1, Tb+1 to Tb+2, and Tb+2 to Tb+3, respectively. In this example, the a/b combined signal of each line has the same data amount as the a signal of each line within the target region 301 for focus detection, and the readout times are the same length for both, as indicated by the sizes of the rectangles.

FIG. 4B is a conceptual diagram illustrating image data 300 read out from the image sensor 107, image data 310 stored in the image memory 109 as a result of the signal processing unit 108 processing the image data 300, and the captured subject 400. In the image data 300, the readout time for each line in the target region 301 for focus detection read out at time Ta to Tb is double compared to the other regions, and thus the way in which the subject 400 is distorted is different. In this region 301, even in the image data 310 stored in the image memory 109, the way in which the subject 400 is distorted is different for the lines La to Lb−1 than in the other regions.

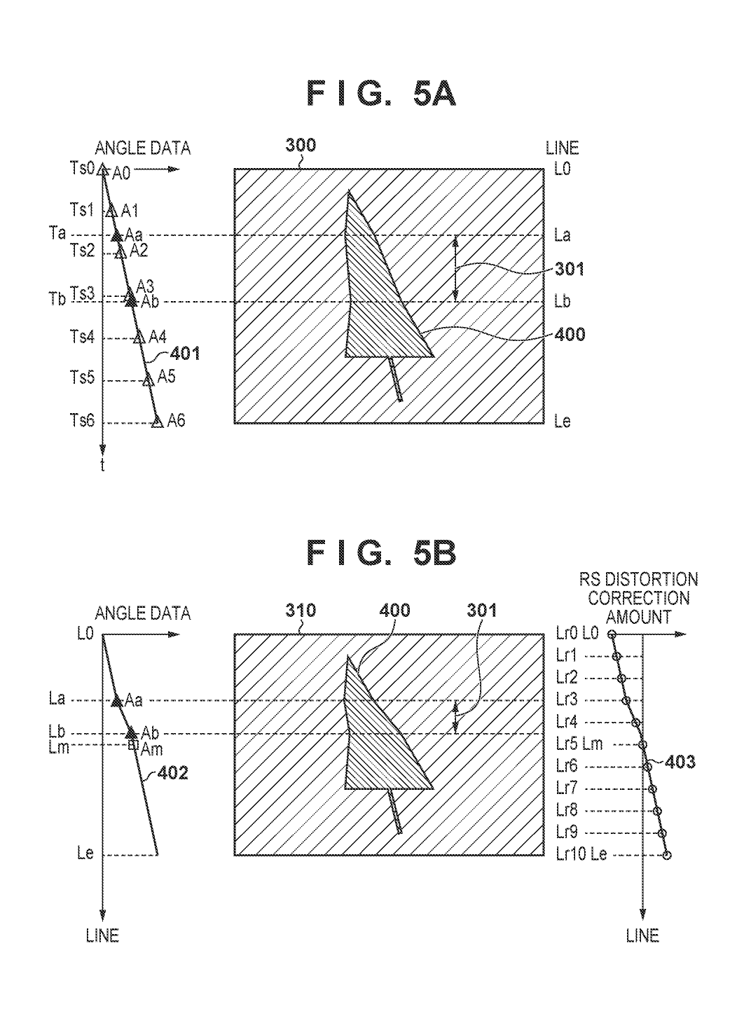

Details of the processing carried out by the RS distortion correction amount computation unit 113 according to the first embodiment will be described next using FIGS. 5A and 5B.

In the graph on the left side in FIG. 5A, the vertical axis represents time and the horizontal axis represents yaw direction angle data generated by the RS distortion correction amount computation unit 113. The graph illustrates an example of the course of shake in the yaw direction produced in the image capturing apparatus 100 during a period in which the image data 300 is read out from the image sensor 107. A timing Ts0 corresponds to a charge accumulation timing for the top line of the image data 300, whereas a timing Ts6 corresponds to a charge accumulation timing for the bottom line of the image data 300. The RS distortion correction amount computation unit 113 starts integrating the angular velocity data in synchronization with Ts0, and generates angle data AO to A6 at timings Ts0 to Ts6 in a predetermined interval instructed by the control microcomputer 101. The RS distortion correction amount computation unit 113 then uses an interpolation method such as linear interpolation, polynomial approximation, or the least-squares method to calculate angle data 401 that is continuous with respect to the time axis from the generated discrete angle data AO to A6. Here, angle data at a readout start time Ta of the target region 301 for focus detection is indicated by Aa, and angle data at a readout end time Tb is indicated by Ab.

The graph on the left side in FIG. 5B indicates an angle data result obtained by converting the course of the angle data 401 that is continuous with respect to the time axis, illustrated in FIG. 5A, into a course of angle data for each of the lines in the image data 310 stored in the image memory 109. The RS distortion correction amount computation unit 113 converts the angle data in consideration of the readout time for a single line in the target region 301 for focus detection set by the control microcomputer 101 as double of the readout time of other regions. As a result, the period of Ts0 to Ta, the period of Ta to Tb, and the period of Tb to Ts6 are converted into angle data 402 for lines L0 to La, lines La to Lb, and lines Lb to Le, respectively. Here, the angle data for a starting line La in the target region for focus detection 301 is indicated by Aa, and the angle data for a line Lb next to a line where the target region for focus detection 301 ends is indicated by Ab. A line Lm is the intermediate line of the image data 310, and the angle data for the intermediate line Lm is indicated by Am.

The RS distortion correction amount computation unit 113 converts the pitch direction and roll direction angle data with respect to the time axis to data with respect to the lines in the same manner as the yaw direction angle data. The details of this processing are the same as for the yaw direction, and thus descriptions thereof will be omitted here.

The graph on the right side in FIG. 5B indicates RS distortion correction amounts for each of the lines in the image data 310, calculated by the RS distortion correction amount computation unit 113 from the angle data 402. In this embodiment, it is assumed that the RS distortion correction is carried out using the intermediate line Lm as a reference. In other words, the angle data Am of the intermediate line Lm is subtracted from the angle data 402, such that the RS distortion correction amount is 0 at the intermediate line Lm. A yaw direction RS distortion correction amount 403 is obtained by calculating a translational moving amount of the subject image on the image capturing plane corresponding to a unit angle with respect to the focal length of the imaging optical system 104 set by the control microcomputer 101, and multiplying that amount with the angle data 402 from which the angle data Am has been subtracted. In this embodiment, the RS distortion correction unit 114 is assumed to be set with the RS distortion correction amount 403 for each of the lines Lr0 to Lr10 provided at equal intervals in the vertical direction of the image data. The RS distortion correction amount computation unit 113 finds the RS distortion correction amount 403 for the lines Lr0 to Lr10 and communicates the amount to the control microcomputer 101. Having received the RS distortion correction amount 403, the control microcomputer 101 sets that RS distortion correction amount 403 in the RS distortion correction unit 114.

The RS distortion correction unit 114 controls the readout range according to the RS distortion correction amount 403, in the same manner as the readout range 510, and reads out part of the image data 310. As a result, the RS distortion can be corrected properly even in the case where there are lines, in the same image plane, for which the readout takes more time than for the other lines.

The RS distortion correction amount computation unit 113 calculates RS distortion correction amounts from the angle data for the pitch direction and the roll direction in the same manner as for the yaw direction, and sets those amounts in the RS distortion correction unit 114 via the control microcomputer 101. The details of the processing are largely the same as for the yaw direction and thus will not be described here. With respect to the roll direction, it is not necessary to find the translational moving amount from the focal length of the imaging optical system 104 when finding the RS distortion correction amount from the angle data, and the angle data that takes the intermediate line Lm as 0 is used as-is as the RS distortion correction amount.

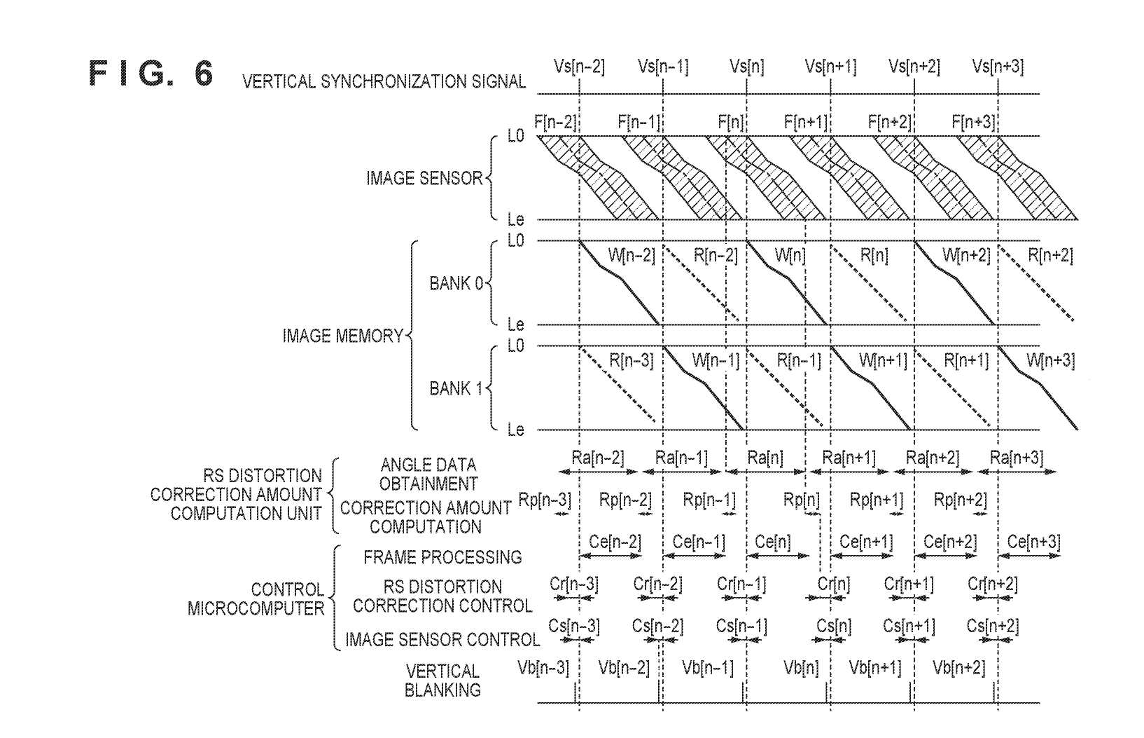

An operation sequence of the image capturing apparatus 100 will be described next using the timing chart in FIG. 6.

In FIG. 6, the uppermost pulse signal, indicated by Vs, is a vertical synchronization signal, and the [ ] following thereafter indicate target frames. The image data is processed continuously, one frame at a time, with each block of the image capturing apparatus 100 operating in synchronization. Note that the source and distribution paths of the vertical synchronization signal are not illustrated in FIG. 1. Here, Vs[n−2] to Vs[n+3] indicate six pulses at equal intervals, and [n−2] to [n+3] will also be used in the following descriptions, using the vertical synchronization signal as a reference.

The lowermost pulse signal, indicated by Vb[ ], is a vertical blanking signal, which notifies the control microcomputer 101 of a timing at which a period for pausing the readout of the image data from the image sensor 107 starts. Note that the source and distribution paths of the vertical blanking signal are not illustrated in FIG. 1. For example, a vertical blanking signal Vb[n−1] is notified at the start of a blanking interval immediately previous to a vertical synchronization signal Vs[n].

The hatched bands indicated by F[ ] indicate driving timings for the lines in the image sensor 107 in each frame, and F[n−2] to F[n+3] indicate the driving timings with respect to six sequential frames of the captured image. The upper end of each band indicates the top line L0 of the image sensor 107, and the lower end of each band indicates the bottom line Le of the image sensor 107. The left side of each band indicates a charge accumulation start timing of each line, whereas the right side of each band indicates the readout timing of each line. As one example, the charge accumulation for the top line L0, indicated by F[n], starts after waiting for the charge accumulation start timing, based on an instruction from the control microcomputer 101, following the vertical synchronization signal Vs[n−1] immediately previous. The readout of the top line L0 indicated by F[n] is carried out in synchronization with the vertical synchronization signal Vs[n]. The bands are bent partway through because the length of the readout time of each line is different between the focus detection region and the other regions. The start of charge accumulation is sequentially shifted from the top line L0 toward the bottom line Le. The speed of the shift of the charge accumulation start is the same as the speed of the shift of the readout. In other words, the driving is carried out such that the slopes and intervals of the left and right sides of the band indicated by F[n] are the same, and the lengths of the charge accumulation times are the same for all lines. The dot-dash lines located between the left and right sides indicate the centers of the charge accumulation periods of each line on the time axis. When the RS distortion correction amount computation unit 113 obtains the angle data, which will be described later, the obtainment is carried out in synchronization with the centers of the charge accumulation periods on the time axis.

W[ ] and R[ ] indicate a write timing and a readout timing for each line of the image data stored in the image memory 109. A capacity for storing two images' worth of image data, in a bank 0 and a bank 1, is provided in the image memory 109. The banks used for writing the image data from the signal processing unit 108 and reading out the image data to the RS distortion correction unit 114 are switched in an alternating manner on the basis of instructions from the control microcomputer 101. In the banks 0 and 1, the upper ends correspond to the top line L0 of the stored image data, and the lower ends correspond to the bottom line Le of the stored image data. Note that the line segments of the readout timings R[ ] do not reach the L0 and Le because, as described using FIGS. 3A to 3D, a predetermined multiple is provided such that the readout range of the RS distortion correction unit 114 does not exceed the overall range of the stored image data.

The write timing W[ ] corresponds to the readout timing of each line indicated by F[ ], and the image data read out from the image sensor 107 is written into the image memory 109 via the signal processing unit 108. For example, a readout timing R[n] is synchronized with the vertical synchronization signal Vs[n+1] that is one frame after the vertical synchronization signal Vs[n], and the readout range of the image data written at W[n] is read out by the RS distortion correction unit 114. The read-out image data undergoes RS distortion correction, and is output to the display unit 116 and the recording unit 118 via the display control unit 115 and the recording control unit 117, respectively.

Ra[ ] indicates a period in which the RS distortion correction amount computation unit 113 obtains the angle data. The RS distortion correction amount computation unit 113 generates the angle data at a timing corresponding to a predetermined interval based on instructions from the control microcomputer 101, in synchronization with the center of the charge accumulation period of each line on the time axis, indicated by the dot-dash line for F[ ]. For example, the timings Ts0 to Ts6 at equal intervals, described with reference to FIG. 5A, are provided in the period Ra[ ] in each frame, and the angle data AO to A6 is generated for F[ ] at each timing.

Rp[ ] indicates a period in which the RS distortion correction amount to be set in the RS distortion correction unit 114 is calculated from the angle data generated by the RS distortion correction amount computation unit 113. In each frame, the RS distortion correction amount computation unit 113 calculates the RS distortion correction amount in the period indicated by Rp[ ] on the basis of the focus detection target region set by the control microcomputer 101, after the period Ra[ ] for generating the angle data for F[ ] has ended.

Ce[ ] indicates a period in which the control microcomputer 101 carries out frame processing for each block. The frame processing Ce[ ] is started in synchronization with the vertical synchronization signal Vs[ ] of that same frame. Here, “frame processing” refers to main subject determination, automatic exposure (auto exposure; AE) processing, autofocus (AF) processing, and memory bank control for reading and writing from and to the image memory 109.

In the main subject determination, the control microcomputer 101 determines a main subject present in the image data from the result of the detection performed by the subject detection unit 111. The main subject part is used for controlling the AE processing, AF processing, and so on. It is assumed that the subject detection unit 111 reads out the image data from the image memory 109 and detects the subject simultaneously with the RS distortion correction unit 114. For example, when the timing R[n] of the readout from the image memory 109 ends, the result of subject detection for the image data indicated by F[n] is obtained for the same frame. The result of the subject detection for F[n−2], which corresponds to R[n−2] ending at that point in time, is used in the frame processing Ce[n]. Although the subject detection is described here as being carried out on the pre-RS distortion correction image data, the configuration may be such that the subject detection is carried out on the post-RS distortion correction image data. In this case, the subject can be detected without being affected by RS distortion. However, doing so also increases an amount of delay from the detection to the result being used in the AE processing, AF processing, and so on, which worsens the ability to follow the subject.

In the AE processing, the control microcomputer 101 determines driving parameters for the aperture of the imaging optical system 104, the charge accumulation start timing for the image sensor 107, and so on using the result of exposure evaluation carried out by the signal processing unit 108 on the image data and the main subject determination result. The main subject determination result is used in order to give the exposure evaluation a greater weight for the main subject region than in other regions. The exposure evaluation is carried out when the image data is read out from the image sensor 107, and thus when the readout for F[n] ends, for example, a result for the image data corresponding to F[n] is obtained. In the frame processing Ce[n], the AE processing is carried out using the result of the exposure evaluation corresponding to F[n−1], which has ended by that point in time.

In the AF processing, the control microcomputer 101 determines driving parameters of the focus lens 105 of the imaging optical system 104, the target region for focus detection of the image sensor 107, and so on using the defocus amount of the subject image calculated by the focus evaluation unit 110 and the subject detection result. The main subject determination result is used in order to determine the target region for focus detection and give the defocus amount a greater weight for the main subject region than in other regions. The focus evaluation is carried out when the image data is read out from the image sensor 107, and thus when the readout for F[n] ends, for example, a result for the image data corresponding to F[n] is obtained. In the frame processing Ce[n], the AF processing is carried out using the defocus amount of the subject image corresponding to F[n−1] obtained at that point in time.

In the memory bank control, the control microcomputer 101 controls the bank of the image memory 109 into which the signal processing unit 108 writes the image data and the bank from which the RS distortion correction unit 114 reads out the image data, as described with reference to W[ ] and R[ ]. For example, the bank control of W[n+1] and R[n] starting with the next vertical synchronization signal Vs[n+1] is carried out in Ce[n].

Cr[ ] indicates a period in which the control microcomputer 101 controls the RS distortion correction. In the RS distortion correction control, for example, a notification that the RS distortion correction amount computation unit 113 has calculated the RS distortion correction amount at Rp[n] is received, the RS distortion correction amount is obtained at Cr[n] in the same frame, and that amount is set in the RS distortion correction unit 114. Furthermore, using the results of the AE processing and the AF processing, the timing at which the angle data is obtained in Ra[n+2] started after the next vertical synchronization signal Vs[n+1] and the target region for focus detection used in Rp[n+2] corresponding to that timing are set for the RS distortion correction amount computation unit 113.

Cs[ ] indicates a period in which the control microcomputer 101 controls the image sensor 107. For example, upon receiving a notification of the vertical blanking signal Vb[n], the charge accumulation start timing at F[n+2], where the charge accumulation after the next vertical synchronization signal Vs[n+1] is started, and the target region for focus detection, are set for the image sensor 107, using the results of the AE processing and the AF processing in Cs[n].

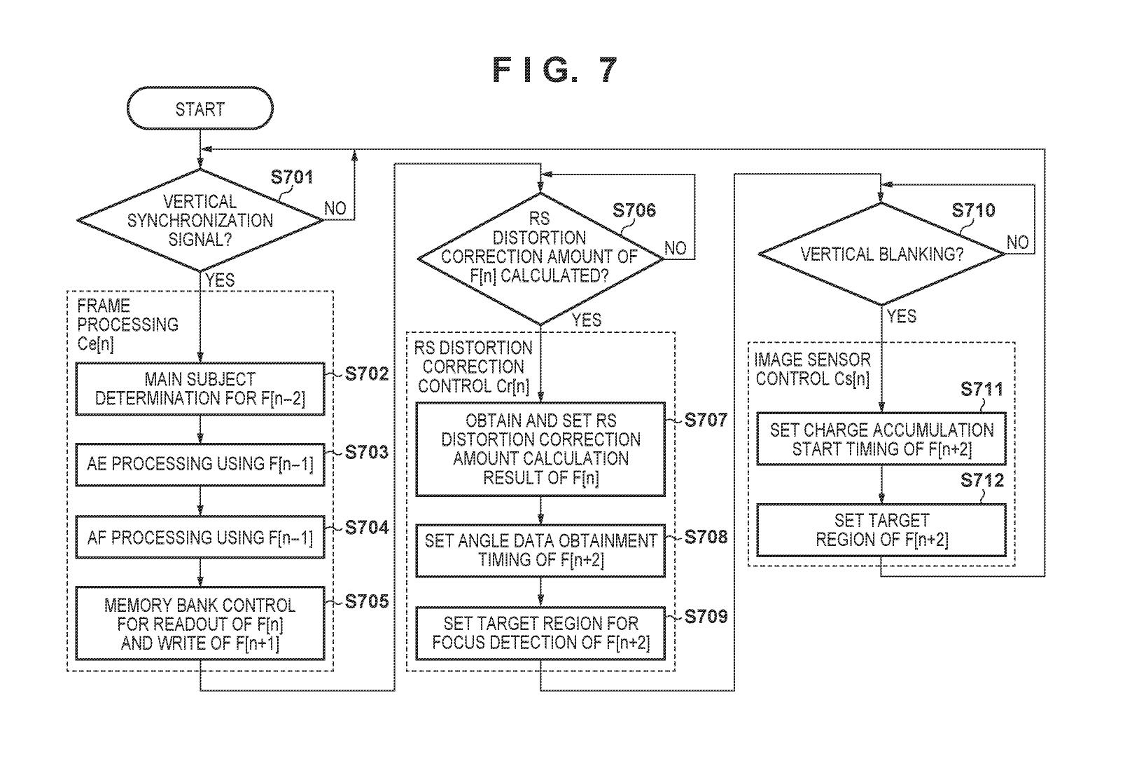

Next, details of the processing carried out by the control microcomputer 101 when the image capturing apparatus 100 processes one frame of the image data at a time will be described using the flowchart in FIG. 7. This processing corresponds to the control periods Ce[ ], Cr[ ], and Cs[ ] of the control microcomputer 101, illustrated in FIG. 6.

In step S701, the control microcomputer 101 stands by for the vertical synchronization signal, and the process moves to S702 upon the vertical synchronization signal being received. The processing from S702 to S705 is the frame processing of Ce[ ], indicated in FIG. 6. To clearly indicate the frames being processed in each step, the descriptions here will be given using Ce[n] as a reference.

In step S702, the above-described main subject determination is carried out using the results of the subject detection in F[n−2]. In step S703, the above-described AE processing is carried out using the result of the exposure evaluation in F[n−1] and the result of the main subject determination in step S702. In step S704, the above-described AF processing is carried out using the subject defocus amount in F[n−1] and the result of the main subject determination in S702.

In step S705, the above-described memory bank control is carried out for the write W[n+1] into the image memory 109 in F[n+1] and the readout R[n] from the image memory 109 in F[n].

In step S706, the control microcomputer 101 stands by for a notification from the RS distortion correction amount computation unit 113 that the calculation of the RS distortion correction amount has ended. If this is immediately after the processing of Ce[n], the control microcomputer 101 stands by for the processing to the corresponding Rp[n] to end.

The processing from step S707 to step S709 is the RS distortion correction control of Cr[ ], indicated in FIG. 6. The descriptions here will be given using Cr[n], corresponding to the above-described Ce[n] and Rp[n], as a reference.

In step S707, the RS distortion correction amount in F[n], calculated by the RS distortion correction amount computation unit 113 in Rp[n], is obtained and set in the RS distortion correction unit 114. In step S708, the timing at which the RS distortion correction amount computation unit 113 obtains the angle data for F[n+2] is set using the results of the AE processing and the AF processing. In step S709, the target region for focus detection used by the RS distortion correction amount computation unit 113 for F[n+2] is set using the result of the AF processing.

In step S710, the control microcomputer 101 waits for a notification of the vertical blanking signal, and moves the process to step S711 upon receiving the vertical blanking signal. The processing of steps S711 and S712 is the control for the image sensor 107 in Cs[ ], indicated in FIG. 6.

In step S711, the charge accumulation start timing of the image sensor 107 is set for F[n+2] using the results of the AE processing and the AF processing carried out immediately before. In step S712, the target region for focus detection of the image sensor 107 is set for F[n+2] using the result of the AF processing carried out immediately before, and the process then returns to step S701.

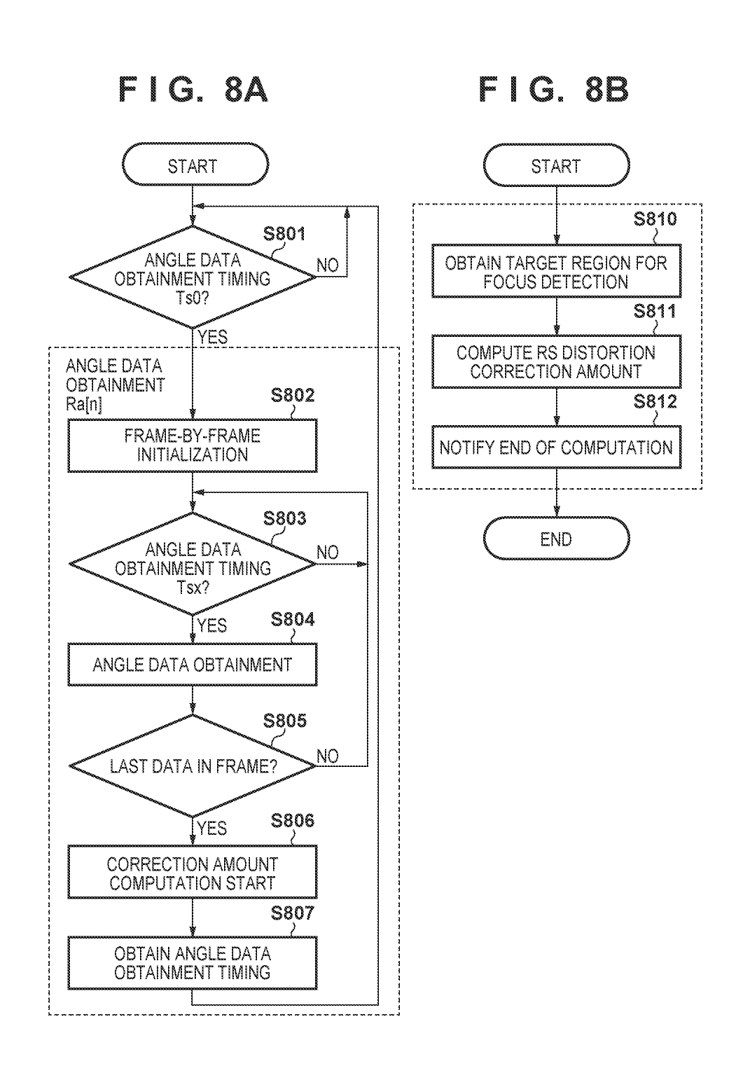

Details of the processing through which the RS distortion correction amount computation unit 113 calculates the RS distortion correction amount for each frame of the image data will be described next using the flowcharts in FIGS. 8A and 8B. The RS distortion correction amount computation unit 113 carries out the processing illustrated in FIGS. 8A and 8B in parallel through a control method such as multitasking.

FIG. 8A is a flowchart illustrating the details of processing for obtaining the angle data, corresponding to Ra[ ] indicated in FIG. 6. To clearly indicate the frames being processed in each step, the descriptions here will be given using Ra[n] as a reference.

In step S801, the RS distortion correction amount computation unit 113 waits for an angle data obtainment timing Ts0 already set by the control microcomputer 101. As described with reference to FIGS. 5A and 5B, the angle data obtainment timing is a timing corresponding to a predetermined interval synchronized with the center of the charge accumulation period of each line on the time axis, and Ts0 is the timing for the top line. In response to Ts0, the processing of Ra[n], from step S802 on, is carried out.

In step S802, initialization is carried out on a frame-by-frame basis. Specifically, integral values of the angular velocity data obtained from the angular velocity sensor 112 are reset, an internal counter is initialized, a memory region of unnecessary data is released, and so on. In step S803, the RS distortion correction amount computation unit 113 waits for an angle data obtainment timing Tsx already set by the control microcomputer 101. As described with reference to FIGS. 5A and 5B, Tsx indicates six timings, namely Ts1 to Ts6, provided at equal intervals after Ts0 and up until the timing of the last line, namely Ts6. Upon reaching the obtainment timing, in step S804, the angle data for Tsx is obtained from the integral value of the angular velocity data obtained from the angular velocity sensor 112.

In step S805, it is determined whether the angle data obtained in step S804 is the final data in the frame. Here, it is determined whether the angle data for Ts6 has been obtained. If the obtained data is not the final data, the internal counter is advanced and the process returns to step S803, where the RS distortion correction amount computation unit 113 waits for the next angle data obtainment timing.

In the case where the angle data obtained in step S804 is the final data in the frame, in step S806, a correction amount computation process, illustrated in FIG. 8B, is started and carried out in parallel with the processing of FIG. 8B.

In step S807, the angle data obtainment timing set by the control microcomputer 101 is obtained, the processing returns to step S801, and the obtained timing is used in the processing for the next frame. As described above, the obtainment timing for F[n+2] is set in Cr[n]. Accordingly, in the last instance of step S807 in Ra[n], the obtainment timing set in Cr[n−1] for F[n+1] is obtained and used in the processing of Ra[n+1].

FIG. 8B is a flowchart illustrating the details of the process of computing the RS distortion correction amount, corresponding to Rp[ ] indicated in FIG. 6, and is started in step S806 of FIG. 8A. To clearly indicate the frames being processed in each step, the descriptions here will be given using R[n] as a reference.

In step S810, the target region for focus detection set by the control microcomputer 101 is obtained. As described above, the target region for focus detection for F[n+2] is set in Cr[n], and thus the details set in Cr[n−2] are obtained in Rp[n]. In S811, the RS distortion correction amount for F[n] is calculated as described with reference to FIGS. 5A and 5B, from the target region for focus detection obtained in step S810 and the angle data obtained in FIG. 8A.

In S812, the control microcomputer 101 is notified that the calculation of the RS distortion correction amount is complete, and the processing ends.

As described thus far, according to the first embodiment, rolling shutter distortion in captured image data can be properly corrected even if the length of the readout time differs from line to line of the image sensor.

### Second Embodiment

Next, a second embodiment of the present invention will be described. An image capturing apparatus according to the second embodiment differs from that in the first embodiment in that a plurality of readout modes for reading out the output signals from the image sensor 107 at high speeds are provided, and the RS distortion correction is carried out in accordance with a selected readout mode under the control of the control microcomputer 101. Other points are the same as those described in the first embodiment, and thus only the differences will be described here.

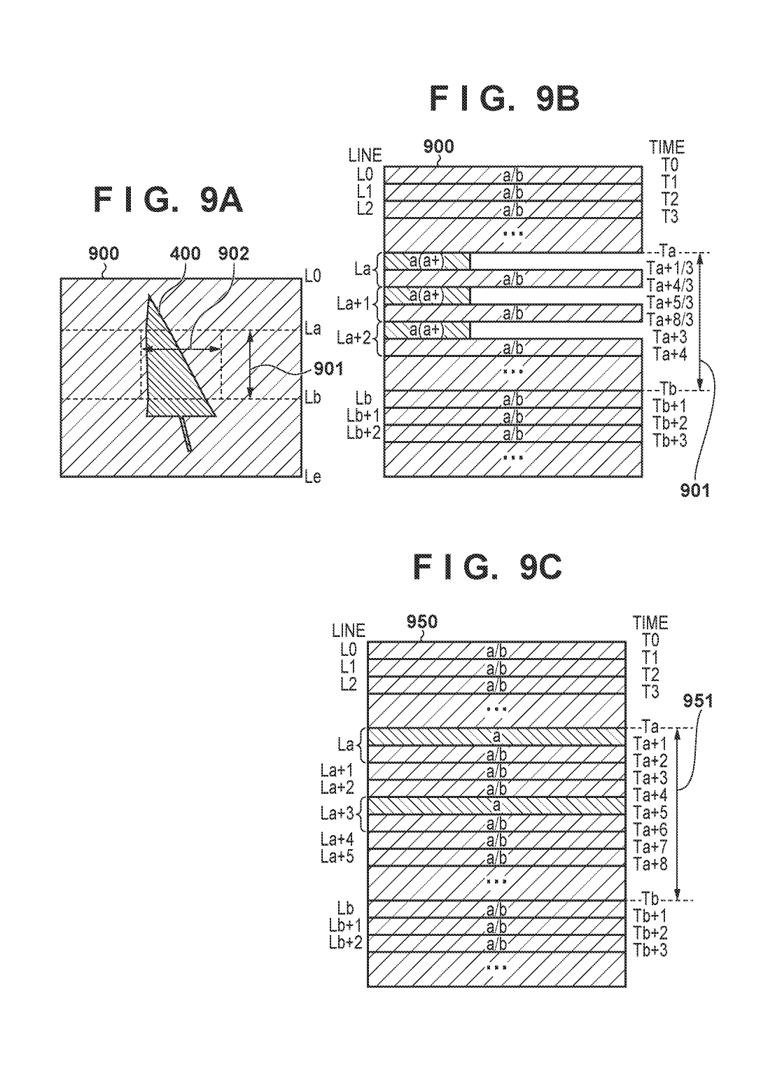

First, readout modes 0 to 3 provided for the image sensor 107 in the second embodiment will be described using FIGS. 9A to 9C.

In mode 0, the target region for focus detection is set only in the vertical direction, and the a signal and the a/b combined signal are sequentially read out from the lines in the region on a line-by-line basis, in the same manner as in the first embodiment. Only the a/b combined signal is read out from the lines outside of the region.

In mode 1, the target region for focus detection is set in the horizontal direction in addition to the vertical direction. FIG. 9A illustrates an example of the target region for focus detection set in mode 1. A region 901 is set in the vertical direction and a region 902 is set in the horizontal direction (a line direction) in image data 900 read out from the image sensor 107. In other words, for each unit pixel in the lines contained in the region 901, the a signal and the a/b combined signal are read out in line sequence for the unit pixels contained in the region 902. Only the a/b combined signal is read out in the other regions. Here, as one example, the region 902 is a region ⅓ the horizontal size of the overall image data 900, in the center thereof.

FIG. 9B is a diagram in which an example of the image data 900 read out from the image sensor 107 in mode 1 is depicted on a line-by-line basis. Like the example illustrated in FIG. 4A, the rectangles a/b in FIG. 9B indicate the a/b combined signal, and the rectangles a indicate the a signal. Only the a/b combined signal is read out in the lines L0, L1, and L2, which correspond to regions outside of the target region for focus detection. In the lines La, La+1, and La+2, which are contained in the target region for focus detection, the a signal contained in the region 902, and the a/b combined signal contained in all regions in the horizontal direction, are read out in line sequence. The length of each rectangle in the horizontal direction indicates the size of the data to be read out, and because the a signal has a readout region ⅓ the size of the a/b combined signal in the same line, the data size is also ⅓ the size thereof. As such, the readout times of the lines La, La+1, and La+2 contained in the region 901 are 4/3 times those of the lines L0, L1, and L2 contained in the region 901.

Additionally, in mode 1, the signal processing unit 108 generates the b signal only for the unit pixels from which the a signal has been read out, and the focus evaluation unit 110 only calculates the defocus amount of the subject image in that region. Although this narrows the region in which focus detection can be carried out, the readout time is shortened, which suppresses the amount of RS distortion that is produced.

In mode 2, the target region for focus detection is set only in the vertical direction, in the same manner as in mode 0. Mode 2 differs from mode 0 in that the pixels in the periphery of the a signal are added together and read out in the target region for focus detection. The a signal added and read out will be called an “a+ signal”. An adding circuit (not illustrated) incorporated into the signal path leading to the output from the image sensor 107 adds the a signals among unit pixels adjacent to each other in the horizontal direction after being output from the circuit of each unit pixel illustrated in FIG. 2 to obtain the a+ signal. Here, it is assumed that three pixels in the horizontal direction are added together at a time and read out as a single pixel. In the image data read out from the image sensor 107 at this time, the data size of the a+ signal in the target region for focus detection is ⅓ the size of the a/b combined signal, and thus has the same data size as the example of mode 1 illustrated in FIG. 9B.

In mode 2, the signal processing unit 108 adds, in the target region for focus detection, the a/b combined signals in the horizontal direction according to the same combinations as for the a+ signals, and uses the result to calculate a b+ signal corresponding to added b signals. The focus evaluation unit 110 calculates the defocus amount of the subject image using the a signals and the b signals in which the number of pixels in the horizontal direction has been reduced through the adding. Although this reduces the accuracy of the detection of the defocus amount in the horizontal direction, the readout time is shortened, which suppresses the amount of RS distortion that is produced.

In mode 3, the target region for focus detection is set only in the vertical direction, in the same manner as in mode 0. Mode 3 differs from mode 0 in that in the target region for focus detection, the lines from which the a signal is read out are thinned at a predetermined interval. In FIG. 9C, 950 indicates an example of the image data read out from the image sensor 107 in mode 3, depicted on a line-by-line basis. In the example illustrated in FIG. 9C, the lines from which the a signal is read out are thinned to ⅓. In a target region for focus detection 951, the readout time for the lines La and La+3, from which the a signal is read out, is double that of the other lines, but the readout time for a single line in the region 951 as a whole is 4/3 times. Here, it is assumed that the number of lines in the region 951 is divided by 3.

In mode 3, the signal processing unit 108 calculates the b signal only for the lines from which the a signal is read out, and the focus evaluation unit 110 calculates the defocus amount of the subject image for the lines using only the a signal and the b signal obtained from these lines. Although this reduces the accuracy of the detection of the defocus amount in the vertical direction, the readout time is shortened, which suppresses the amount of RS distortion that is produced.

An example in which the data size of each line read out from the target region for focus detection in modes 1 to 3 is 4/3 times that of other regions has been described here for the sake of simplicity. However, the multiple need not be 4/3, and other multiples may be used instead. In other words, the size of the horizontal region may be provided at any desired ratio, the number of pixels added may be set to a different number of pixel, and the number of lines that are thinned may be set to a different value. Additionally, to shorten the readout time of the a signal, the configuration may be such that a readout method providing a different readout time than that of the a/b combined signal, such as carrying out an operation for reducing the bit accuracy of the a signal compared to the a/b combined signal, is employed.

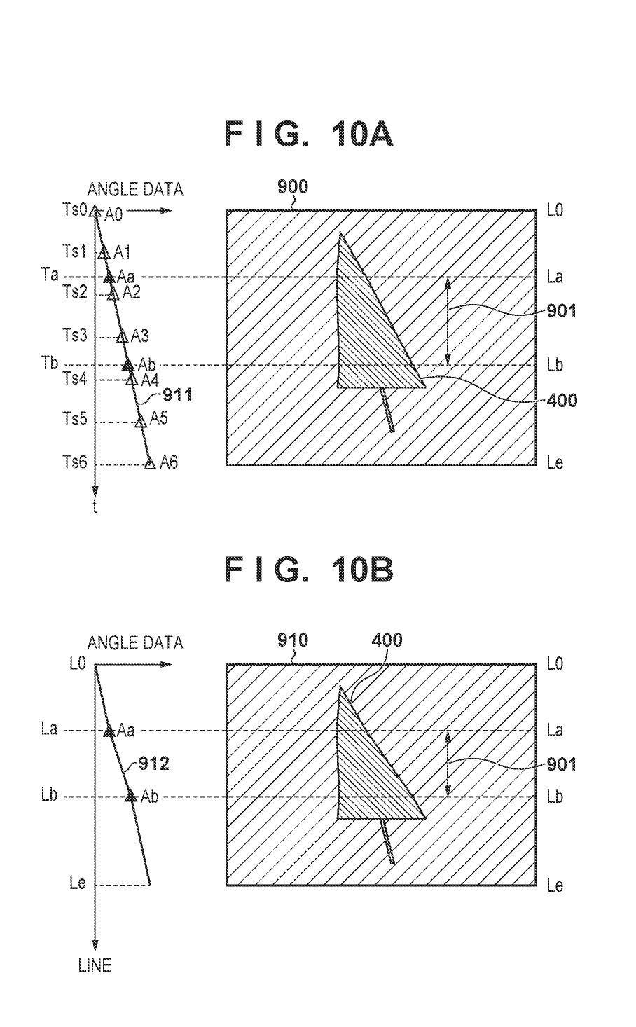

Details of the processing carried out by the RS distortion correction amount computation unit 113 according to the second embodiment will be described next using FIGS. 10A and 10B.

The graph on the left side in FIG. 10A is, like the graph in FIG. 5A, an example of the yaw direction angle data generated by the RS distortion correction amount computation unit 113 while the image data 900 is being captured. As described using FIGS. 9A to 9C, it is assumed that the readout time for each line in the region 901 is 4/3 times that in the other regions. The RS distortion correction amount computation unit 113 generates the angle data AO to A6 at the timings Ts0 to Ts6 corresponding to predetermined intervals instructed by the control microcomputer 101, and on the basis thereof, calculates angle data 911 that is continuous with respect to the time axis. Like FIG. 5A, angle data at the readout start time Ta of a target region 901 for subject detection is indicated by Aa, and angle data at the readout end time Tb is indicated by Ab.

The graph on the left side in FIG. 10B indicates a result of converting the course of the angle data 911 that is continuous with respect to the readout time, illustrated in FIG. 10A, into a course of angle data for each of the lines in image data 910 stored in the image memory 109. The angle data for the period of Ts0 to Ta, the period of Ta to Tb, and the period of Tb to Ts6 are converted into angle data for lines L0 to La, lines La to Lb, and lines Lb to Le, respectively. Thereafter, the RS distortion correction amount computation unit 113 calculates the RS distortion correction amount from the obtained angle data 912 and communicates that amount to the control microcomputer 101 so as to control the RS distortion correction, in the same manner as described in the first embodiment.

As described thus far, according to the second embodiment, rolling shutter distortion in captured image data can be corrected even in the case where the readout time differs in a variety of ways from region to region of the image sensor.

### Third Embodiment

Next, a third embodiment of the present invention will be described. The third embodiment differs from the above-described first embodiment in terms of the method by which the control microcomputer 101 assigns the target region for focus detection and the processing carried out by the RS distortion correction amount computation unit 113. Other points are the same as those described in the first embodiment, and thus only the differences will be described here.

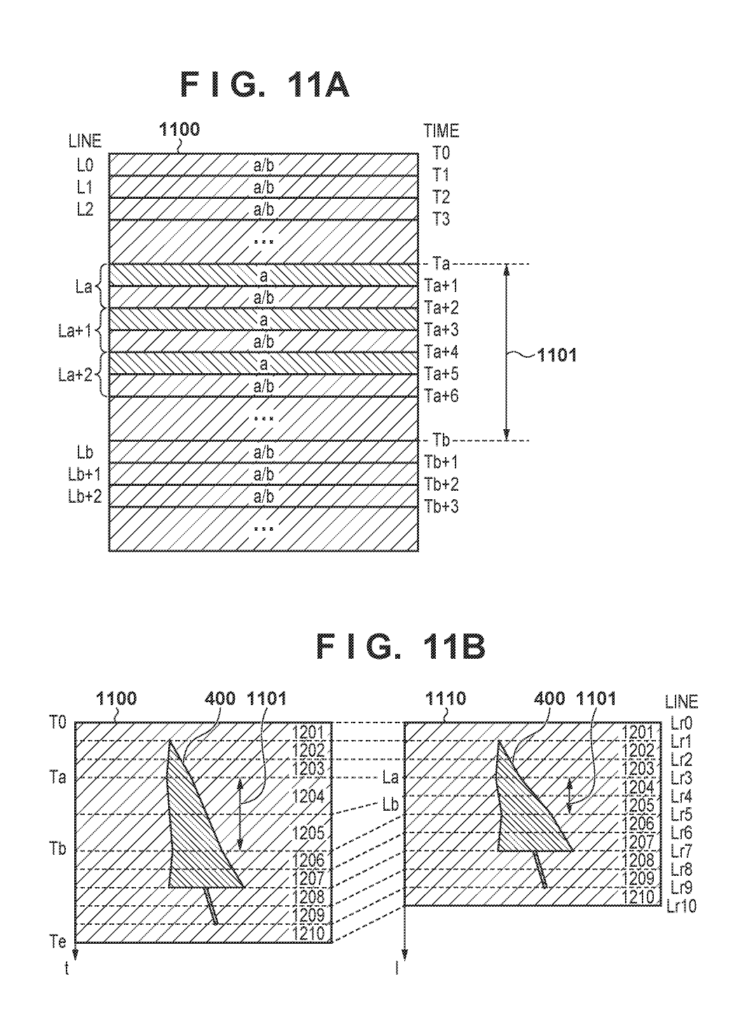

First, image data read out from the image sensor 107 and image data stored in the image memory 109 in the case where focus detection image data is read out from a predetermined region of the image sensor 107 in the third embodiment will be described using FIGS. 11A and 11B.

In FIG. 11A, reference numeral 1100 indicates an example in which the type of the image data read out from the image sensor 107 is indicated for each line. This is assumed to be the same as in FIG. 4A.

FIG. 11B is a conceptual diagram illustrating the image data 1100 read out from the image sensor 107, image data 1110 stored in the image memory 109 as a result of the signal processing unit 108 processing the image data 1100, and the captured subject 400. In the third embodiment, the control microcomputer 101 divides the image capturing plane of the image sensor 107 into 10 parts at equal intervals in the vertical direction, and assigns the target region for subject detection by region obtained from this division. Here, a target region for focus detection 1101 in the image data 1100 read out from the image sensor 107 is assigned to division regions 1204 and 1205 among division regions 1201 to 1210 obtained from the division into 10 parts. The readout time for each line in the division regions 1204 and 1205 is double that in the other regions. As such, the division regions 1204 and 1205 are illustrated at double the size in the time axis direction, and the way in which the subject is distorted is also different. In the image data 1110 stored in the image memory 109, the vertical direction lengths of the division regions 1204 and 1205, based on the number of lines, are the same as in the other regions, but the way in which the subject is distorted is different from the other regions.

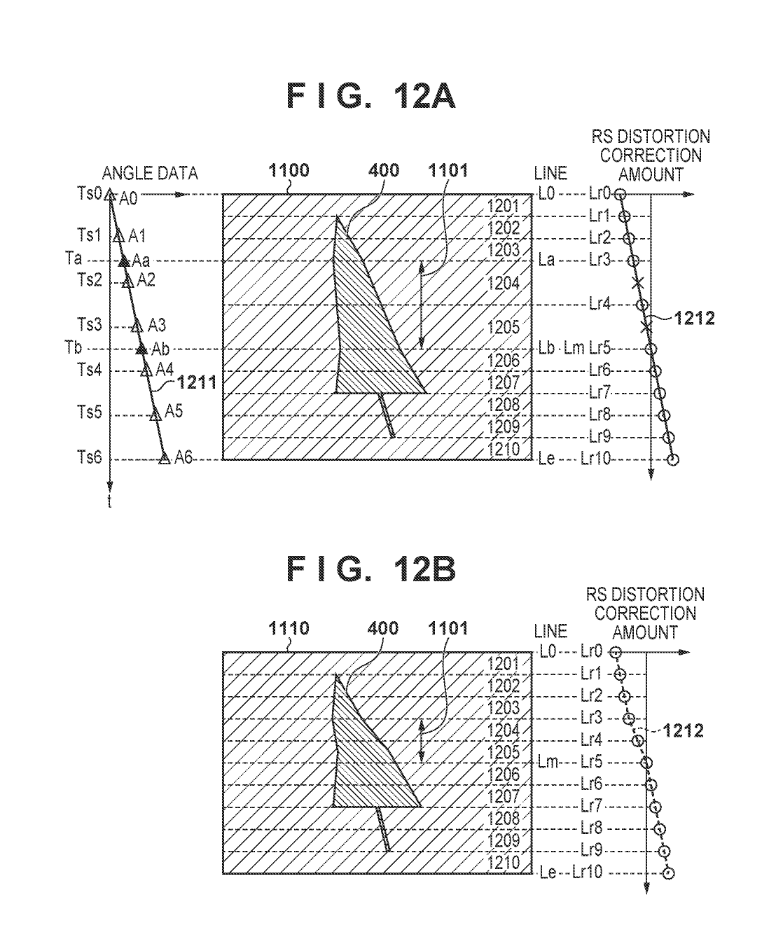

Details of the processing carried out by the RS distortion correction amount computation unit 113 according to the third embodiment will be described next using FIGS. 12A and 12B.

In the graph on the left side in FIG. 12A, the vertical axis represents time and the horizontal axis represents yaw direction angle data generated by the RS distortion correction amount computation unit 113. The graph illustrates an example of the course of shake in the yaw direction produced in the image capturing apparatus 100 during a period in which the image data 1100 is read out from the image sensor 107. A timing Ts0 corresponds to a charge accumulation timing for the top line of the image data 1100, whereas a timing Ts6 corresponds to a charge accumulation timing for the bottom line of the image data 1100. The RS distortion correction amount computation unit 113 starts integrating the angular velocity data in synchronization with Ts0, and generates angle data AO to A6 at timings Ts0 to Ts6 in a predetermined interval instructed by the control microcomputer 101. The RS distortion correction amount computation unit 113 then uses an interpolation method such as linear interpolation, polynomial approximation, or the least-squares method to calculate angle data 1211 that is continuous with respect to the time axis from the generated discrete angle data AO to A6. Here, angle data at a readout start time Ta of the target region 1101 for focus detection is indicated by Aa, and angle data at a readout end time Tb is indicated by Ab.

In the graph on the right side in FIG. 12A, the horizontal axis represents the RS distortion correction amount in the horizontal direction, and reference numeral 1212 indicates an RS distortion correction amount, continuous with respect to the time axis, calculated by the RS distortion correction amount computation unit 113 from the angle data 1211. In the third embodiment, it is assumed that the RS distortion correction is carried out using the intermediate line Lm as a reference. Here, boundaries between the division regions 1201 to 1210 are taken as the lines Lr0 to Lr10, and thus Lr5 corresponds to the intermediate line Lm. First, the RS distortion correction amount computation unit 113 obtains angle data that is 0 at the intermediate line by subtracting the angle data Ab at the intermediate line Lr5 from the image data 1100. A continuous RS distortion correction amount 1212 is obtained by calculating a translational moving amount of the subject image on the image capturing plane corresponding to a unit angle with respect to the focal length of the imaging optical system 104 set by the control microcomputer 101, and multiplying that amount with the angle data obtained as a result. In the third embodiment, the RS distortion correction unit 114 is assumed to take an RS distortion correction amount setting for the lines Lr0 to Lr10. The RS distortion correction amount computation unit 113 finds the RS distortion correction amount for the lines Lr0 to Lr10 and communicates the amount to the control microcomputer 101. As described above, the division regions 1204 and 1205 has double the size in the time axis direction than the other eight division regions, and thus the RS distortion correction amounts for the lines Lr0 to Lr10 are values indicated by 0 and x, at parts obtained by dividing the RS distortion correction amount 1212 into 8+2×2=12 parts in the time axis direction. However, the RS distortion correction amount is not set at the lines corresponding to the parts indicated by x, and thus not used. Having received the notification, the control microcomputer 101 sets the RS distortion correction amount 1212 in the RS distortion correction unit 114.

The graph on the right side in FIG. 12B indicates the RS distortion correction amount 1212 of the lines Lr0 to Lr10, obtained as described with reference to FIG. 12A, against the image data 1110 stored in the image memory 109. The change in the RS distortion correction amount in the graph corresponds to the way in which the subject is distorted in the image data 1110, and the RS distortion correction amount 1212 calculated at the time axis can be used as-is as the RS distortion correction amount 1212 for that line position.

The RS distortion correction amount computation unit 113 calculates RS distortion correction amounts from the angle data for the pitch direction and the roll direction, in the same manner as for the yaw direction, and sets those amounts in the RS distortion correction unit 114 via the control microcomputer 101. The details of the processing are largely the same as for the yaw direction and thus will not be described here. However, with respect to the roll direction, it is not necessary to find the translational moving amount from the focal length of the imaging optical system 104 when finding the RS distortion correction amount from the angle data, and the angle data that takes the intermediate line L5 as 0 is used as-is as the RS distortion correction amount 1212.

As described thus far, according to the third embodiment, rolling shutter distortion in captured image data can be properly corrected even if the length of the readout time differs from line to line in an assigned region of the image sensor.

### Fourth Embodiment

Next, a fourth embodiment of the present invention will be described. An image capturing apparatus according to the fourth embodiment differs from that in the third embodiment in that a plurality of readout modes for reading out the output signals from the image sensor 107 at high speeds are provided, and the RS distortion correction is carried out in accordance with a selected readout mode under the control of the control microcomputer 101. Other points are the same as those described in the third embodiment, and thus only the differences will be described here.

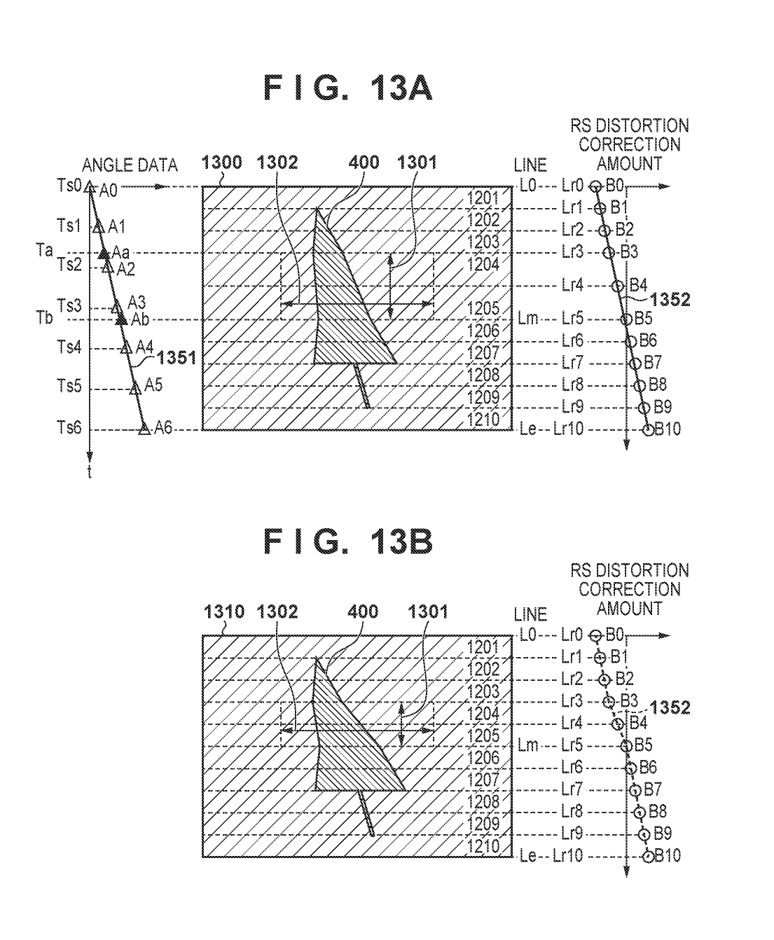

Next, the details of processing carried out by the RS distortion correction amount computation unit 113 in each of readout modes 0 to 3 provided for the image sensor 107 in the fourth embodiment will be described using FIGS. 13A and 13B.

In mode 0, division regions to serve as the target region for focus detection are set only in the vertical direction, and the a signal and the a/b combined signal are sequentially read out from the lines in the target regions for focus detection on a line-by-line basis, in the same manner as in the third embodiment. Only the a/b combined signal is read out from the lines outside of the region.

In mode 1, the target region for focus detection is set in the horizontal direction in addition to the division regions in the vertical direction. FIG. 13A illustrates an example of the details of the processing carried out by the RS distortion correction amount computation unit 113 in mode 1. Of the division regions obtained by dividing the image data 1300 read out from the image sensor 107 into ten equal parts in the vertical direction, a target region 1301 for focus detection is set in the division regions 1204 and 1205, and a region 1302 in the horizontal direction is then set within the region 1301. In other words, in the lines contained in the region 1301, the a signal and the a/b combined signal are read out in line sequence for the unit pixels contained in the region 1302. Only the a/b combined signal is read out from the unit pixels in the other regions. Here, as one example, the region 1302 is a region ½ the horizontal size of the overall image data 1300, in the center thereof. Accordingly, the readout time of each line contained in the region 1301 is 3/2 times that of the lines not contained in the region 1301.

Additionally, in mode 1, the signal processing unit 108 generates the b signal only for the unit pixels from which the a signal has been read out, and the focus evaluation unit 110 only calculates the defocus amount of the subject image in that region. Although this narrows the region in which focus detection can be carried out, the readout time is shortened, which suppresses the amount of RS distortion that is produced.

The graph on the left in FIG. 13A indicates yaw direction angle data generated by the RS distortion correction amount computation unit 113, where reference numeral 1351 indicates continuous angle data calculated from the discrete angle data AO to A6, in the same manner as in FIG. 12A. In the graph on the right side, reference numeral 1352 indicates an RS distortion correction amount continuous with respect to the time axis, calculated by the RS distortion correction amount computation unit 113 from the angle data 1351, also in the same manner as in FIG. 12A. Here, too, the RS distortion correction is assumed to be carried out using the intermediate line Lm, namely Lr5, as a reference. The RS distortion correction amount computation unit 113 finds the RS distortion correction amount for the lines Lr0 to Lr10 and communicates the amount to the control microcomputer 101. As described above, the division regions 1204 and 1205 have 3/2 times the size, in the time axis direction, as the other eight division regions. In consideration of this, the positions of the lines Lr0 to Lr10 on the time axis are calculated and the RS distortion correction amount is found for each position. Having received the notification, the control microcomputer 101 sets that RS distortion correction amount in the RS distortion correction unit 114.

The graph on the right side in FIG. 13B indicates the RS distortion correction amount of the lines Lr0 to Lr10, obtained as described with reference to FIG. 13A, against image data 1310 stored in the image memory 109. The change in the RS distortion correction amount 1352 in the graph corresponds to the way in which the subject is distorted in the image data 1310, and the RS distortion correction amount 1352 calculated at the time axis can be used as-is as the RS distortion correction amount 1352 for that line position.

In mode 2, the target region for focus detection is set only in the division regions in the vertical direction, in the same manner as in mode 0. Mode 2 differs from mode 0 in that the pixels in the periphery of the a signal are added together and read out in the target region for focus detection. The a signal added and read out will be called an “a+ signal”. An adding circuit (not illustrated) incorporated into the signal path leading to the output from the image sensor 107 adds the a signals among unit pixels adjacent to each other in the horizontal direction after being output from the circuit of each unit pixel illustrated in FIG. 2 to obtain the a+ signal. Here, it is assumed that two pixels in the horizontal direction are added together at a time and read out as a single pixel. In the image data read out from the image sensor 107 at this time, the data size of the a+ signal in the target region for focus detection is ½ the size of the a/b combined signal. Accordingly, the readout time of each line contained in the region 1301 is 3/2 times that of the lines not contained in the region 1301. Here, the multiple of the readout time for each line contained in the region 1301 is the same in both mode 1 and mode 2, and thus the details of the processing carried out by the RS distortion correction amount computation unit 113 is as indicated in FIGS. 13A and 13B in mode 2 as well.

In mode 2, the signal processing unit 108 adds, in the target region for focus detection, the a/b combined signals in the horizontal direction according to the same combinations as for the a+ signals, and uses the result to calculate a b+ signal corresponding to added b signals. The focus evaluation unit 110 calculates the defocus amount of the subject image using the a signals and the b signals in which the number of pixels in the horizontal direction has been reduced through the adding. Although this reduces the accuracy of the detection of the defocus amount in the horizontal direction, the readout time is shortened, which suppresses the amount of RS distortion that is produced.

In mode 3, the target region for focus detection is set only in the division regions in the vertical direction, in the same manner as in mode 0. Mode 3 differs from mode 0 in that in the target region for focus detection, the lines from which the a signal is read out are thinned at a predetermined interval. For example, the lines from which the a signal is read out in the region 1301 are thinned to ½. The readout time for the lines from which the a signal is read out is double that of the other lines, but the readout time for a single line in the region 1301 as a whole is 3/2 times. Here, the multiple of the readout time for each line contained in the region 1301 is the same in mode 3 as in modes 1 and 2, and thus the details of the processing carried out by the RS distortion correction amount computation unit 113 is as indicated in FIGS. 13A and 13B in mode 3 as well.

In mode 3, the signal processing unit 108 calculates the b signal only for the lines from which the a signal is read out, and the focus evaluation unit 110 calculates the defocus amount of the subject image for the lines using only the a signal and the b signal obtained from these lines. Although this reduces the accuracy of the detection of the defocus amount in the vertical direction, the readout time is shortened, which suppresses the amount of RS distortion that is produced.

An example in which the data size of each line read out from the target region for subject detection in modes 1 to 3 is 3/2 times that of other regions has been described here for the sake of simplicity. However, the multiple need not be 3/2, and other multiples may be used instead. In other words, the size of the horizontal region may be provided at any desired ratio, the number of pixels added may be set to a different number of pixel, and the number of lines that are thinned may be set to a different value. Additionally, to shorten the readout time of the a signal, the configuration may be such that an operation is carried out to reduce the bit accuracy of the a signal compared to the a/b combined signal.

As described thus far, according to the fourth embodiment, rolling shutter distortion in captured image data can be corrected even in the case where the readout time differs in a variety of ways from region to region of the image sensor.

### Fifth Embodiment

Next, a fifth embodiment of the present invention will be described. An image capturing apparatus according to the fifth embodiment differs from that of the fourth embodiment in that the timing at which the angular velocity data is obtained, instructed to the RS distortion correction amount computation unit 113 by the control microcomputer 101, is synchronized with charge accumulation in division regions. Other points are the same as those described in the fourth embodiment, and thus only the differences will be described here.

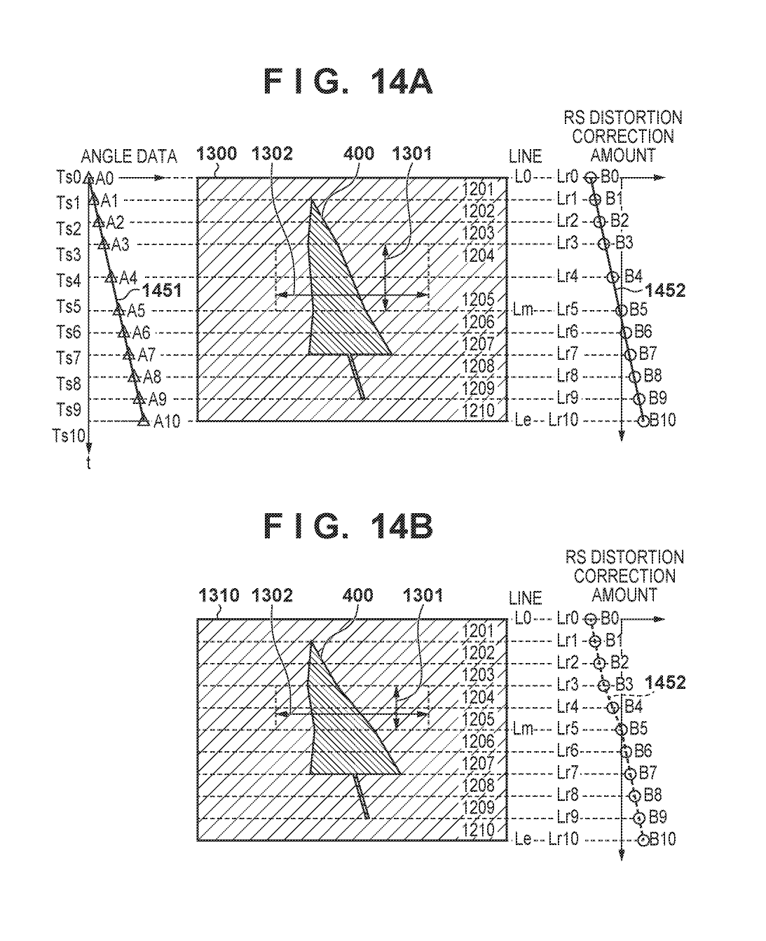

Details of the processing carried out by the RS distortion correction amount computation unit 113 according to the fifth embodiment will be described using FIGS. 14A and 14B.

As in FIG. 13A, in the graph on the left side in FIG. 14A, the vertical axis represents time, and the horizontal axis represents yaw direction angle data 1451 generated by the RS distortion correction amount computation unit 113. The graph illustrates an example of the course of yaw direction shake produced in a period in which the image data 1300 is read out from the image sensor 107. Of the division regions 1201 to 1210 obtained by dividing the image capturing plane of the image sensor 107 into ten parts at equal intervals in the vertical direction, a target region 1301 for focus detection is assigned to the division regions 1204 and 1205.

In the fifth embodiment, the timings Ts0 to Ts10 at which the RS distortion correction amount computation unit 113 obtains the angle data on the basis of instructions from the control microcomputer 101 are synchronized with the charge accumulation timings of the lines Lr0 to Lr10, which correspond to the boundaries between the division regions. In other words, the charge accumulation timing of each division region corresponds in a manner such that the timing Ts0 corresponds to the top line in the division region 1201, the timing Ts' corresponds to the top line in the division region 1202, and the timing Ts10 corresponds to the bottom line of the division region 1210. The RS distortion correction amount computation unit 113 starts integrating the angular velocity data in synchronization with Ts0, and generates angle data AO to A10 at the timings Ts0 to Ts10 instructed by the control microcomputer 101.

In the graph on the right side in FIG. 14A, the horizontal axis represents an RS distortion correction amount 1452 in the horizontal direction, calculated by the RS distortion correction amount computation unit 113. In the fifth embodiment too, the RS distortion correction is assumed to be carried out using the intermediate line Lm, namely Lr5, as a reference. Here, the angle data AO to A10 is obtained for the lines Lr0 to Lr10 for which the RS distortion correction amount 1452 is to be found. Therefore, even if the continuous angle data is not calculated from the discrete angle data, the corresponding RS distortion correction amount can be calculated directly from the discrete angle data. In other words, the RS distortion correction amount computation unit 113 obtains each piece of angle data, with data of 0 at the intermediate line, by subtracting the angle data at the intermediate line Lr5 from the angle data of the lines Lr0 to Lr10. This angle data is A5 in FIG. 14A. The RS distortion correction amount 1452 is obtained for the lines Lr0 to Lr10 by calculating a translational moving amount of the subject image on the image capturing plane corresponding to a unit angle with respect to the focal length of the imaging optical system 104 set by the control microcomputer 101, and multiplying that amount with the angle data obtained as a result. In the fifth embodiment too, it is assumed that the RS distortion correction unit 114 accepts the setting of the RS distortion correction amount 1452 for the lines Lr0 to Lr10, and that the control microcomputer 101 that has been notified of the calculation of the RS distortion correction amount 1452 sets the RS distortion correction amount 1452 in the RS distortion correction unit 114.

As described thus far, according to the fifth embodiment, rolling shutter distortion in captured image data can be corrected through a simpler computation process, even if the length of the readout time differs from region to region of the image sensor.

### Sixth Embodiment

Next, a sixth embodiment of the present invention will be described. An image capturing apparatus according to the sixth embodiment differs from that in the first embodiment in terms of the way in which the RS distortion correction amount computation unit 113 finds the RS distortion correction amount. Other points are the same as those described in the first embodiment, and thus only the differences will be described here.

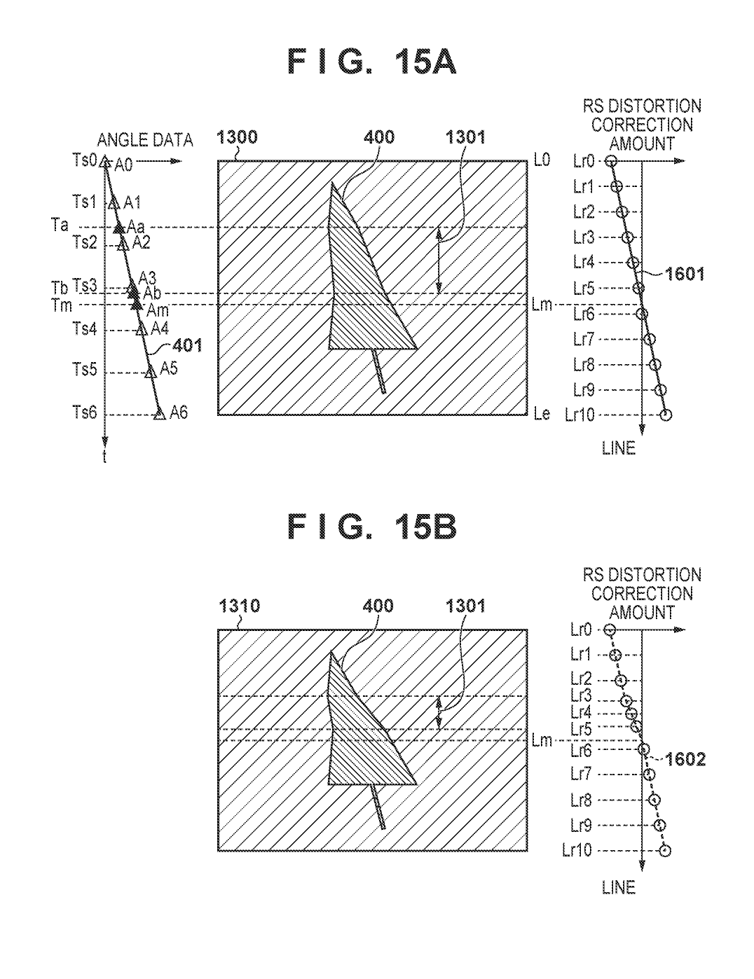

Details of the processing carried out by the RS distortion correction amount computation unit 113 according to the sixth embodiment will be described first using FIGS. 15A and 15B.

In the graph on the left side in FIG. 15A, the vertical axis represents time and the horizontal axis represents yaw direction angle data generated by the RS distortion correction amount computation unit 113. The graph illustrates an example of the course of shake in the yaw direction produced in the image capturing apparatus 100 during a period in which the image data 1300 is read out from the image sensor 107. The timing Ts0 corresponds to a charge accumulation timing for the top line of the image data 1300, whereas the timing Ts6 corresponds to a charge accumulation timing for the bottom line of the image data 1300. The RS distortion correction amount computation unit 113 starts integrating the angular velocity data in synchronization with Ts0, and generates the angle data AO to A6 at the timings Ts0 to Ts6 in a predetermined interval instructed by the control microcomputer 101. The RS distortion correction amount computation unit 113 then uses an interpolation method such as linear interpolation, polynomial approximation, or the least-squares method to calculate angle data 401 that is continuous with respect to the time axis from the generated discrete angle data AO to A6. Here, angle data at the readout start time Ta of the target region 1301 for focus detection is indicated by Aa, and angle data at the readout end time Tb is indicated by Ab.

Meanwhile, in the graph on the right side in FIG. 15A, the horizontal axis represents the RS distortion correction amount in the horizontal direction, and reference numeral 1601 indicates an RS distortion correction amount, continuous with respect to the time axis, calculated by the RS distortion correction amount computation unit 113 from the angle data 401. Lm indicates the intermediate line of the image sensor 107, and in the sixth embodiment, it is assumed that the RS distortion correction is carried out using the intermediate line Lm as a reference. First, the RS distortion correction amount computation unit 113 obtains angle data that is 0 at the intermediate line by subtracting the angle data at the intermediate line Lm, or in other words, Am in the graph on the left side in FIG. 15A, from the angle data 401. A continuous RS distortion correction amount 1601 is obtained by calculating a translational moving amount of the subject image on the image capturing plane corresponding to a unit angle with respect to the focal length of the imaging optical system 104 set by the control microcomputer 101, and multiplying that amount with the angle data obtained as a result. Lr0 to Lr10 are target lines for which the RS distortion correction amount instructed by the control microcomputer 101 is set in the RS distortion correction unit 114. In consideration of the position of the target region for focus detection and the time taken by readout in each line, the control microcomputer 101 arranges, for the image data 1300 to be read out from the image sensor 107, the lines Lr0 to Lr10 at equal intervals on the time axis. The RS distortion correction amount computation unit 113 finds the RS distortion correction amount for the lines Lr0 to Lr10 from the RS distortion correction amount 1601 found in this manner, and communicates the amount to the control microcomputer 101. Having received the notification, the control microcomputer 101 sets that RS distortion correction amount in the RS distortion correction unit 114.

The graph on the right side in FIG. 15B indicates the RS distortion correction amount 1601 of the lines Lr0 to Lr10, obtained as described with reference to FIG. 15A, against the image data 1310 stored in the image memory 109. The positions of the lines Lr0 to Lr10, arranged by the control microcomputer 101 on the basis of time, have, in FIG. 15B, moved to positions based on line positions in the image memory 109. The target region 1301 for focus detection is ½ in the vertical direction, compared to the time axis indicated in FIG. 15A. As such, the intervals of the lines Lr3 to Lr5 contained in the region 301 are ½ the intervals of the lines Lr0 to Lr2 and the lines Lr6 to Lr10. Meanwhile, the intervals of the lines Lr2 and Lr3 and the lines Lr5 and Lr6 straddle the region 1301 and another region, and thus are between ½ and 1 times the intervals of the lines Lr0 to Lr2 and the lines Lr6 to Lr10. The change in an RS distortion correction amount 1602 corresponds to the way in which the subject is distorted in the image data 1310, and the RS distortion correction amount 1601 calculated at the time axis can be used as-is as the RS distortion correction amount 1602 for that line position.

The RS distortion correction amount computation unit 113 calculates RS distortion correction amounts from the angle data for the pitch direction and the roll direction, in the same manner as for the yaw direction, and sets those amounts in the RS distortion correction unit 114 via the control microcomputer 101. The details of the processing are largely the same as for the yaw direction and thus will not be described here. However, with respect to the roll direction, it is not necessary to find the translational moving amount from the focal length of the imaging optical system 104 when finding the RS distortion correction amount from the angle data, and the angle data that takes the intermediate line Lm as 0 is used as-is as the RS distortion correction amount.

Meanwhile, although the operation sequence of the image capturing apparatus 100 is almost the same as that described in the first embodiment with reference to FIG. 6, the processing carried out in Rp[ ] and Cr[ ] is different, and thus Rp[ ] and Cr[ ] will be described below.

Rp[ ] indicates a period in which the RS distortion correction amount to be set in the RS distortion correction unit 114 is calculated from the angle data generated by the RS distortion correction amount computation unit 113. After the period Ra[ ] of generating the angle data for F[ ] has ended, the RS distortion correction amount computation unit 113 calculates the RS distortion correction amount in the period of Rp[ ] for the lines for which the RS distortion correction amount, set by the control microcomputer 101, is to be set in the RS distortion correction unit 114.

Meanwhile, Cr[ ] indicates a period in which the control microcomputer 101 controls the RS distortion correction. In the RS distortion correction control, for example, a notification that the RS distortion correction amount computation unit 113 has calculated the RS distortion correction amount has been calculated at Rp[n] is received, the RS distortion correction amount is obtained at Cr[n], and that amount is set in the RS distortion correction unit 114. Additionally, in the RS distortion correction control, using the results of the AE processing and the AF processing, the timing at which the angle data is obtained in Ra[n+2] started after the next vertical synchronization signal Vs[n+1] is set for the RS distortion correction amount computation unit 113. Furthermore, the positions of the target lines for setting the RS distortion correction amounts used in the RS distortion correction, carried out by the RS distortion correction amount computation unit 113 for Rp[n+2] and by the RS distortion correction unit 114 for F[n+2], are set for the RS distortion correction amount computation unit 113 and the RS distortion correction unit 114. The target lines for setting the RS distortion correction amount are arranged at equal intervals on the time axis with respect to the image data read out from the image sensor 107, as indicated in FIGS. 15A and 15B, using the position of the target region for focus detection determined in the AF processing. The positions of the target lines found in Cr[n] are used in the processing carried out by the RS distortion correction amount computation unit 113 for F[n+2], and thus are extended for use until the processing carried out by the RS distortion correction unit 114 for F[n+2].

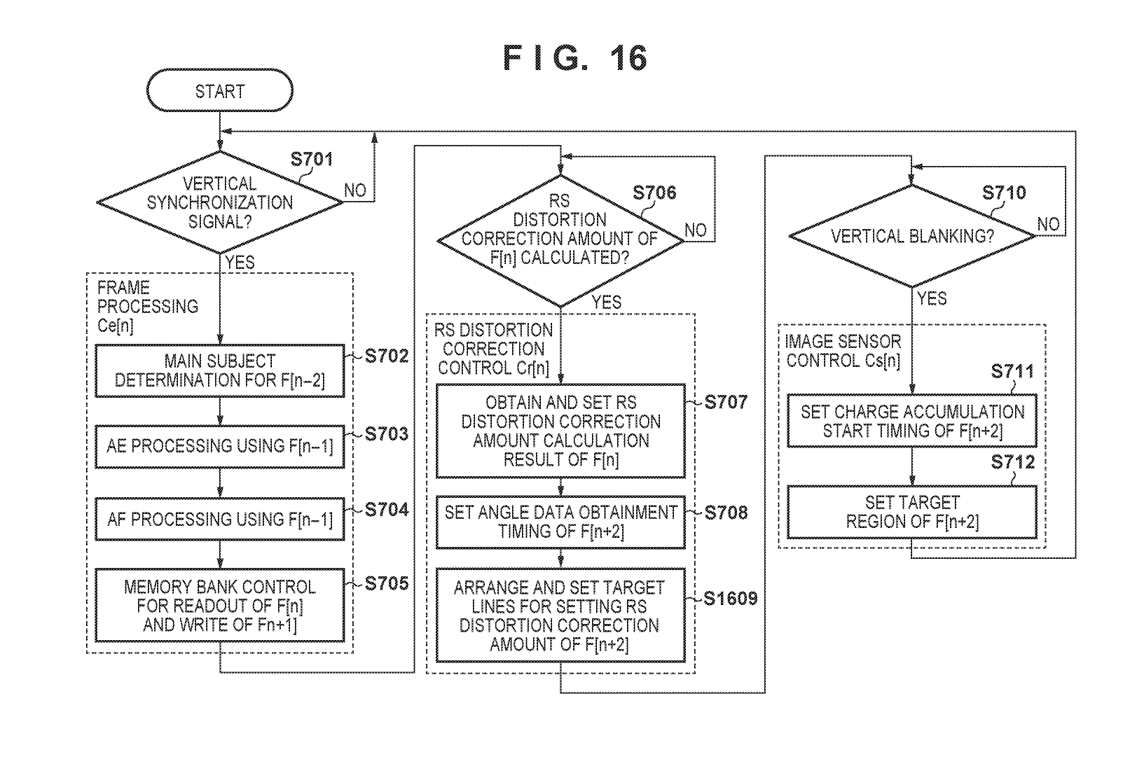

Next, details of the processing carried out by the control microcomputer 101 when the image capturing apparatus 100 processes one frame of the image data at a time will be described using the flowchart in FIG. 16. The processing illustrated in FIG. 16 differs from the processing described in the first embodiment with reference to FIG. 7 in the following ways. In step S709 of FIG. 7, the target region for focus detection used by the RS distortion correction amount computation unit 113 for F[n+2] is set using the result of the AF processing. However, in the sixth embodiment, in step S1609, the target lines for setting the RS distortion correction amount for F[n+2] are arranged using the position of the target region for focus detection determined in the AF processing, and are then set in the RS distortion correction amount computation unit 113 and the RS distortion correction unit 114. The other processes are the same as the processes described with reference to FIG. 7, and therefore descriptions thereof will be omitted.

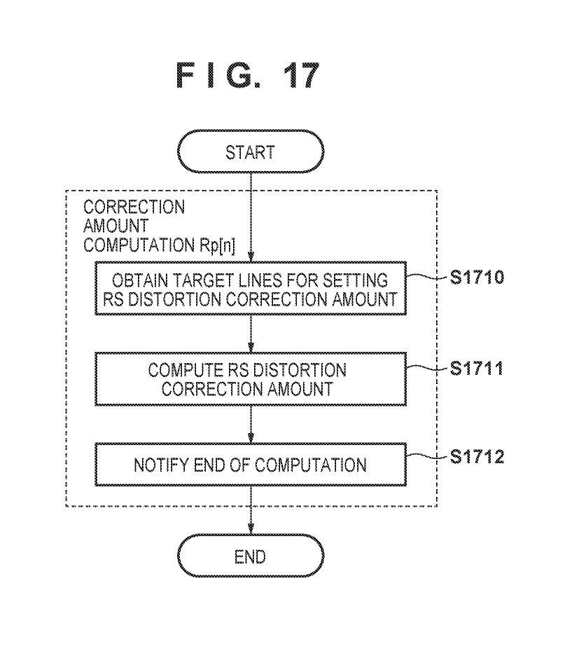

The details of the processing for computing the RS distortion correction amount, corresponding to Rp[ ] in the sixth embodiment, will be described next using the flowchart in FIG. 17. The processing illustrated in FIG. 17 is started in S806 of FIG. 8A. To clearly indicate the frames being processed in each step, the descriptions here will be given using R[n] as a reference.

In step S1710, the target line for setting the RS distortion correction amount set by the control microcomputer 101 is obtained. As described above, the target line is set for F[n+2] in Cr[n], and thus in Rp[n], the details set for Cr[n−2] are obtained. In step S1711, the RS distortion correction amount for F[n] is calculated as described with reference to FIGS. 15A and 15B, from the target line for which the RS distortion correction amount obtained in step S1710 is set and the angle data obtained in FIG. 8A.

In step S1712, the control microcomputer 101 is notified that the calculation of the RS distortion correction amount is complete, and the processing ends.

As described thus far, according to the sixth embodiment, rolling shutter distortion in captured image data can be properly corrected even if the length of the readout time differs from line to line of the image sensor.

### Seventh Embodiment

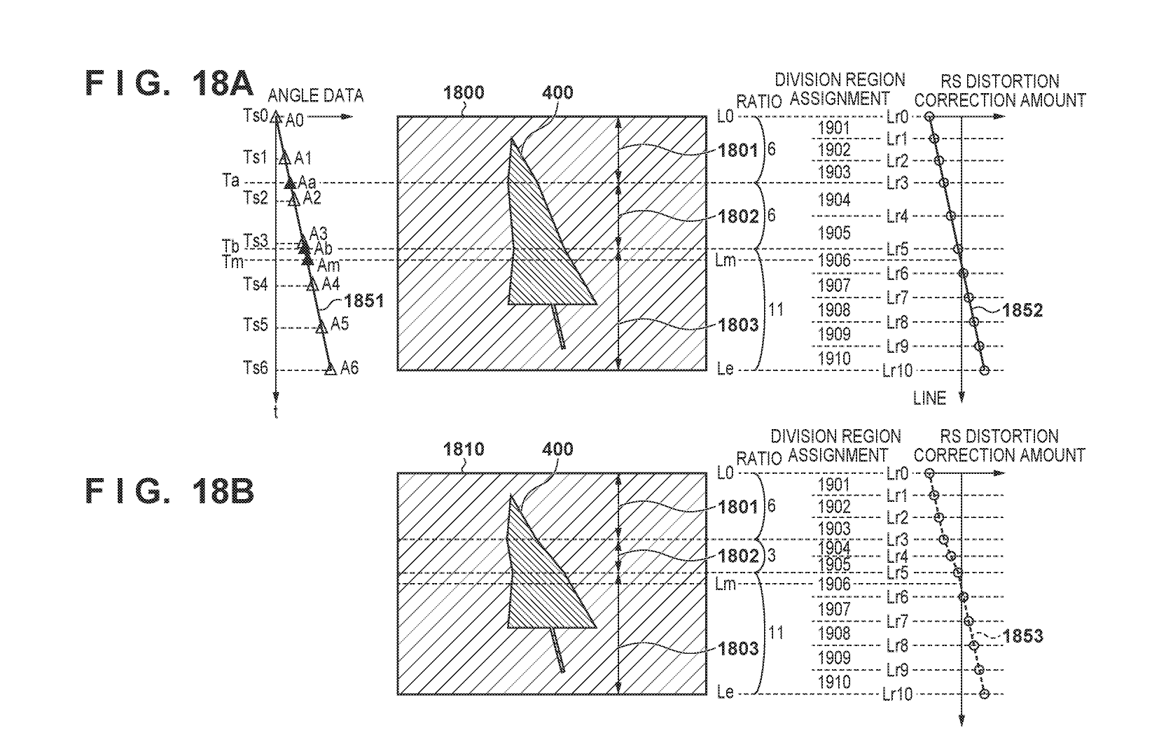

Next, a seventh embodiment of the present invention will be described. The seventh embodiment differs from the above-described sixth embodiment in that some of the target lines for setting the RS distortion correction amount are arranged at boundaries between the target region for focus detection set by the control microcomputer 101 and other regions. The details of the processing for arranging the target lines for which the control microcomputer 101 has set the RS distortion correction amount, and the processing through which the RS distortion correction amount computation unit 113 calculates the RS distortion correction amount, will be described using FIGS. 18A and 18B.

Reference numeral 1800 in FIG. 18A indicates image data read out from the image sensor 107, and reference numeral 1810 in FIG. 18B indicates image data stored in the image memory 109 as a result of the signal processing unit 108 processing the image data 1800. In each piece of image data, reference numeral 1802 indicates the target region for focus detection instructed by the control microcomputer 101, and reference numerals 1801 and 1803 indicate non-target regions. In the example illustrated in FIGS. 18A and 18B, the regions 1801, 1802, and 1803 have a line number ratio of 6:3:11. However, because the length of the readout time for each line in the target region 1802 for focus detection is double that of the other regions, a readout time ratio of the regions is 6:6:11.

In the graph on the left side in FIG. 18A, the vertical axis represents time and the horizontal axis represents yaw direction angle data generated by the RS distortion correction amount computation unit 113. The graph illustrates an example of the course of shake in the yaw direction produced in the image capturing apparatus 100 during a period in which the image data 1800 is read out from the image sensor 107. The timings Ts0 to Ts6 are timings of obtaining the angle data instructed by the control microcomputer 101, and AO to A6 indicate the angle data generated by the RS distortion correction amount computation unit 113 at those timings. Reference numeral 1851 indicates the course of continuous angle data calculated by the RS distortion correction amount computation unit 113 from the discrete angle data AO to A6.

As in FIG. 15A, in the graph on the right side in FIG. 18A, the horizontal axis represents the RS distortion correction amount in the horizontal direction. Reference numeral 1852 indicates a continuous RS distortion correction amount with respect to the time axis, calculated by the RS distortion correction amount computation unit 113 from the angle data 1851, and can be found through the same processing as that used to calculate the RS distortion correction amount 1601 from the angle data 401, described with reference to FIG. 15A. Lr0 to Lr10 are target lines for which the RS distortion correction amount instructed by the control microcomputer 101 is set in the RS distortion correction unit 114. Here, reference numerals 1901 to 1910 are ten division regions obtained by division taking the target lines Lr0 to Lr10 as boundaries. The division regions 1901 to 1910 will be used later to describe processing carried out by the control microcomputer 101.

The top target line Lr0 and the bottom target line Lr10 are assigned in advance to the top line L0 and a bottom Le of the image sensor 107, in the same manner as in FIG. 15A. With respect to the other target lines Lr1 to Lr9, in the seventh embodiment, the control microcomputer 101 first assigns one target line each to the boundaries between the target region 1802 for focus detection and the non-target regions 1801 and 1803. The remaining target lines are then assigned in accordance with the size of each region on the time axis. In the example illustrated in FIG. 18A, the target lines Lr3 and Lr5 are assigned between the regions 1801 and 1802 and between the regions 1802 and 1803, respectively. Lr1 to Lr2, Lr4, and Lr6 to Lr9 are assigned to the regions 1801, 1802, and 1803, respectively. Details regarding the processing through which the control microcomputer 101 assigns the target lines will be given later. The RS distortion correction amount computation unit 113 finds the RS distortion correction amount for the lines Lr0 to Lr10 from the RS distortion correction amount 1852 and communicates the amount to the control microcomputer 101. Having received the notification, the control microcomputer 101 sets that RS distortion correction amount in the RS distortion correction unit 114.

The graph on the right side in FIG. 18B indicates the RS distortion correction amount of the lines Lr0 to Lr10, obtained as described with reference to FIG. 18A, against the image data 1810 stored in the image memory 109. The positions of the lines Lr0 to Lr10, arranged by the control microcomputer 101 on the basis of time, have, in FIG. 18B, moved to positions based on line positions in the image memory 109. The target region 1802 for focus detection is ½ the size in the vertical direction compared to the time axis indicated in FIG. 18A, and thus the interval of the lines Lr3 to Lr5 with respect to the region 1801 is ½ the interval on the time axis. The change in the RS distortion correction amount in the graph corresponds to the way in which the subject is distorted in the image data 1810, and the RS distortion correction amount calculated at the time axis can be used as-is as the RS distortion correction amount for that line position. Additionally, although the way in which the subject is distorted changes in a non-continuous manner at the boundaries between the target region for focus detection 1802 and the other regions 1801 and 1803, the RS distortion correction amount also changes in a non-continuous manner at the boundary parts, and thus the way in which the subject is distorted can be successfully followed.

As described with reference to FIGS. 18A and 18B, the RS distortion correction amount computation unit 113 calculates RS distortion correction amounts from the angle data for the pitch direction and the roll direction, in the same manner as for the yaw direction, and sets those amounts in the RS distortion correction unit 114 via the control microcomputer 101.

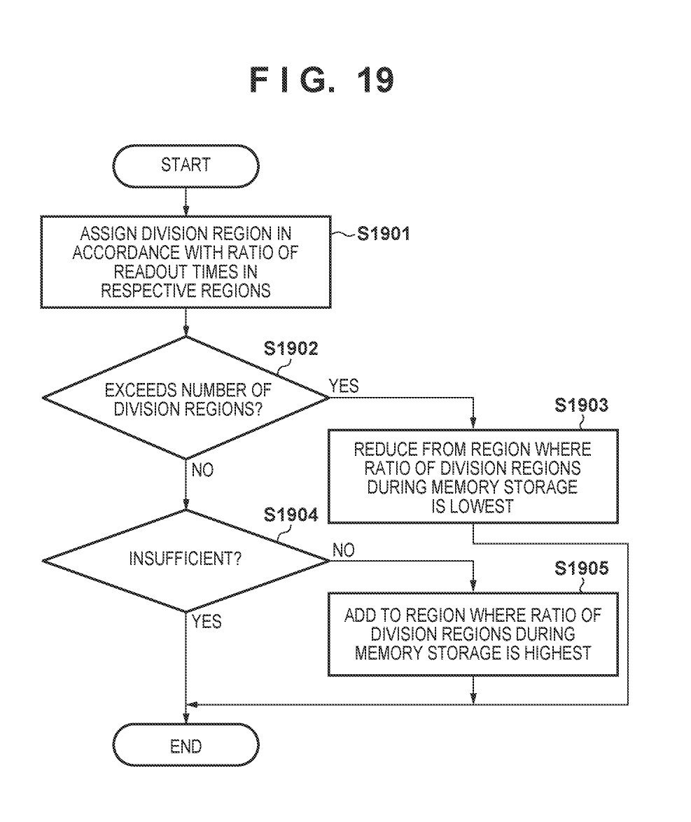

The details of the processing through which the control microcomputer 101 assigns the target lines for setting the RS distortion correction amount will be described next using the flowchart in FIG. 19. In the seventh embodiment, the details of the processing carried out by the control microcomputer 101 when the image capturing apparatus 100 processes the image data one frame at a time are the same as those described in the sixth embodiment with reference to FIG. 16. Furthermore, this processing is carried out when the control microcomputer 101 carries out the processing illustrated in FIG. 16, when the target lines in which the RS distortion correction amount is set are arranged in step S1609.

Of the target lines Lr0 to Lr10 for which the RS distortion correction amount is set, the top and bottom target lines Lr0 and Lr10 are assigned in advance to the top line L0 and the bottom Le of the image sensor 107, as described with reference to FIGS. 18A and 18B. This flowchart illustrates a process through which the positions of the target lines Lr1 to Lr9 are determined by adjusting the ratio of the ten division regions 1901 to 1910 in the image data and assigning the division regions to the target region for focus detection and the other regions. Note that to simplify the descriptions, it is assumed that the total number of the target region for focus detection and the other regions in the image data is 3 or less. For example, although there are no more than three regions, namely the regions 1801, 1802, and 1803, in the example illustrated in FIGS. 18A and 18B, there may be two target regions for focus detection and one other region, or there may only be one target region and one other region.

In step S1901 of FIG. 19, the ten division regions are assigned in accordance with the readout time ratio of the target region for focus detection and the other regions. Specifically, the total number of division regions, namely 10, is divided according to the ratio of the stated regions, and the number of division regions to be assigned to each of the stated regions is determined by rounding off. Additionally, a ratio of each single division region assigned to the stated regions when the image data is stored in the image memory is found and used in the subsequent processing. For example, in the case of the image data 1800 illustrated in FIG. 18A, the ratio of the lengths of the readout times of the regions 1801, 1802, and 1803 is 6:6:11, and thus the assignment of the division regions is found by rounding off 60/23:60/23:110/23, resulting in 3:3:5. Therefore, the ratio of the size of each single division region assigned to the stated regions is, for the regions 1801, 1802, and 1803, 23/3:23/3:23/5, on the time axis. The size of the target region 1802 for focus detection becomes ½ when the image data is stored in the image memory, and thus the ratio of the sizes for each single division region is 23/3:23/6:23/5.

In step S1902, it is determined whether or not the number of division regions assigned to the stated regions in step S1901 exceeds the total number of 10. In the case where the number exceeds the total number, the process moves to step S1903, where the division region assignment is reduced by 1 from the region where the ratio for each single division region when the image data is stored in the memory is the lowest, or in other words, from a region having the narrowest width for the increments of the target lines for which the RS distortion correction amount is set, after which the processing ends. For example, in the case of the image data 1800 illustrated in FIG. 18A, the division regions assigned in step S1901 exceed the total number of 10, and thus the division regions assigned to the target region 1802, in which the ratio is the lowest at 23/6, are reduced by 1. As a result, the assignment of the division regions to the regions 1801, 1802, and 1803 becomes 3:2:5, such that the total number is 10. The size of the division regions when the image data is stored in the image memory 109 is used as a reference when reducing the division region assignments in consideration of the amount of influence on the appearance in display, recording, and so on.

In the case where the number does not exceed the total number in step S1902, the process moves to step S1904, where it is determined whether the number of the division regions assigned to the stated regions in step S1901 is less than the total number of 10. In the case where the number is lower than the total number, the process moves to step S1905, where the division region assignment is increased by 1 from the region where the ratio for each single division region is the highest among the regions aside from the target region for focus detection, or in other words, from a region having the broadest increments of the target lines for which the RS distortion correction amount is set, after which the processing ends.

Through this processing, the ratio of the division regions 1901 to 1910 in the image data can be determined, and the positions of the target lines Lr0 to Lr10 for which the RS distortion correction amount is set can be determined.

As described thus far, according to the seventh embodiment, rolling shutter distortion in captured image data can be properly corrected even if the length of the readout time differs from line to line of the image sensor.

### Eighth Embodiment

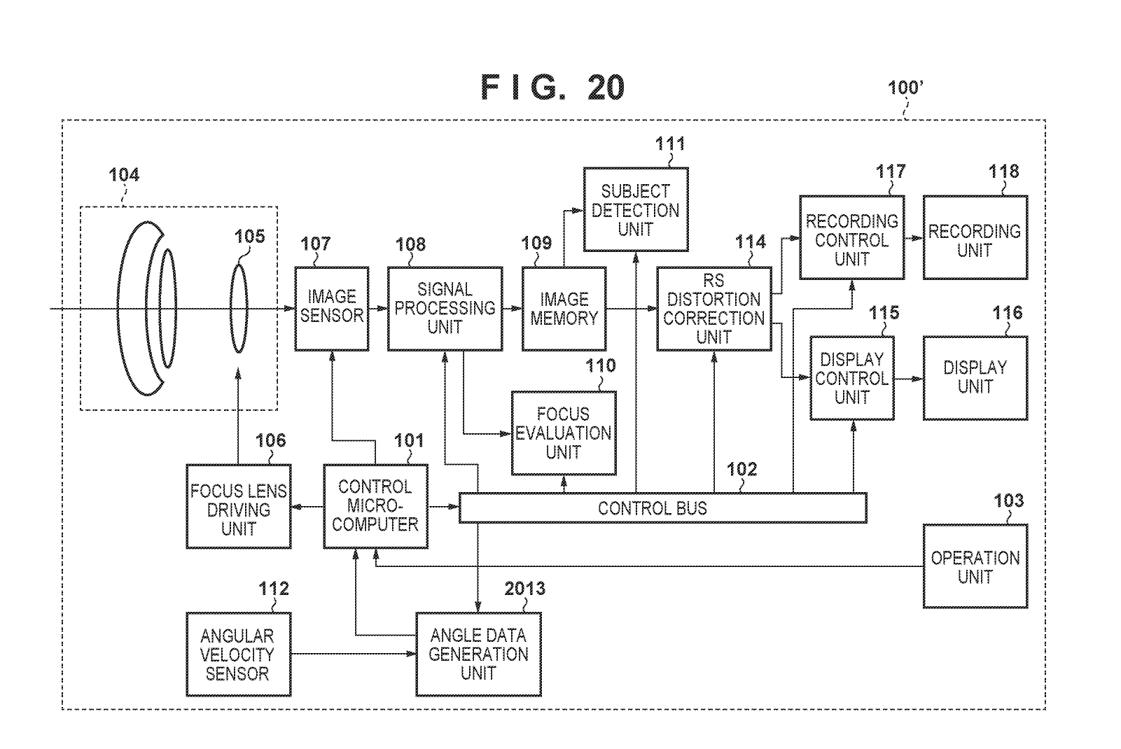

Next, an eighth embodiment of the present invention will be described. FIG. 20 is a block diagram illustrating the configuration of an image capturing apparatus 100′ according to the eighth embodiment of the invention. The image capturing apparatus 100′ differs from the image capturing apparatus 100 described in the first embodiment with reference to FIG. 1 in that an angle data generation unit 2013 is provided instead of the RS distortion correction amount computation unit 113 illustrated in FIG. 1. This configuration changes the processing, and thus the following will describe the processing carried out by the angle data generation unit 2013 and the processing carried out by the respective constituent elements in response thereto.

The angle data generation unit 2013 A/D-converts the angular velocity signals output from the angular velocity sensor 112, integrates angular velocity data obtained as a result, and generates yaw direction, pitch direction, and roll direction angle data at each of timings based on instructions from the control microcomputer 101. The control microcomputer 101 is also notified upon the generation of the angle data ending.

The RS distortion correction unit 114 corrects the RS distortion and outputs the corrected data by reshaping the image data in the image memory 109 on the basis of an RS distortion correction amount calculated from the angle data and set by the control microcomputer 101.

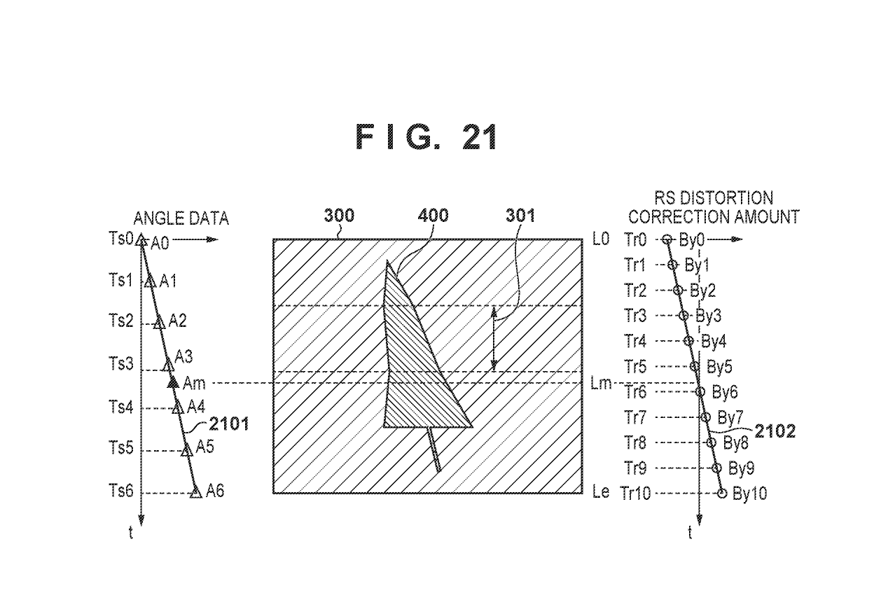

Next, an angle data generation process carried out by the angle data generation unit 2013 and a process through which the control microcomputer 101 calculates the RS distortion correction amount will be described using FIG. 21.

In the graph on the left side in FIG. 21, the vertical axis represents time and the horizontal axis represents yaw direction angle data generated by the angle data generation unit 2013. The graph illustrates an example of the course of shake in the yaw direction produced in the image capturing apparatus 100′ during a period in which the image data 300 is read out from the image sensor 107. The timing Ts0 corresponds to a charge accumulation timing for the top line of the image data 300, whereas the timing Ts6 corresponds to a charge accumulation timing for the bottom line of the image data 300. The angle data generation unit 2013 starts integrating the angular velocity data in synchronization with Ts0, and generates the angle data AO to A6 at the timings Ts0 to Ts6 in a predetermined interval instructed by the control microcomputer 101. The control microcomputer 101 then uses an interpolation method such as linear interpolation, polynomial approximation, or the least-squares method to calculate angle data 2101 that is continuous with respect to the time axis from the discrete angle data AO to A6 generated by the angle data generation unit 2013.

In the graph on the right side in FIG. 21, the horizontal axis represents the RS distortion correction amount in the horizontal direction, and reference numeral 2102 indicates an RS distortion correction amount, continuous with respect to the time axis, calculated by the control microcomputer 101 from the angle data 2101. Lm indicates the intermediate line of the image sensor 107, and in the eighth embodiment, it is assumed that the RS distortion correction is carried out using the intermediate line Lm as a reference. First, the control microcomputer 101 obtains angle data that is 0 at the intermediate line by subtracting the angle data at the intermediate line Lm, or in other words, Am in the graph on the left side in FIG. 21, from the angle data 2101. A continuous RS distortion correction amount 2102 is obtained by calculating a translational moving amount of the subject image on the image capturing plane corresponding to a unit angle with respect to the focal length of the imaging optical system 104, and multiplying that amount with the angle data obtained as a result. Tr0 to Tr10 indicate positions, on the time axis, where the control microcomputer 101 sets the RS distortion correction amount in the RS distortion correction unit 114, and these positions are arranged at equal intervals with respect to charge accumulation periods from the top line L0 to the bottom line Le of the image data 300. The control microcomputer 101 finds the RS distortion correction amounts By0 to By10 for Tr0 to Tr10 from the RS distortion correction amount 2102, and sets those amounts in the RS distortion correction unit 114.

The angle data generation unit 2013 generates angle data for the pitch direction and the roll direction in the same manner as for the yaw direction. The control microcomputer 101 calculates RS distortion correction amounts for those directions and sets those amounts in the RS distortion correction unit 114 via the control microcomputer 101. The details of the processing are largely the same as for the yaw direction and thus will not be described here. However, with respect to the roll direction, it is not necessary to find the translational moving amount from the focal length of the imaging optical system 104 when finding the RS distortion correction amount from the angle data, and the angle data that takes the intermediate line Lm as 0 is used as-is as the RS distortion correction amount.

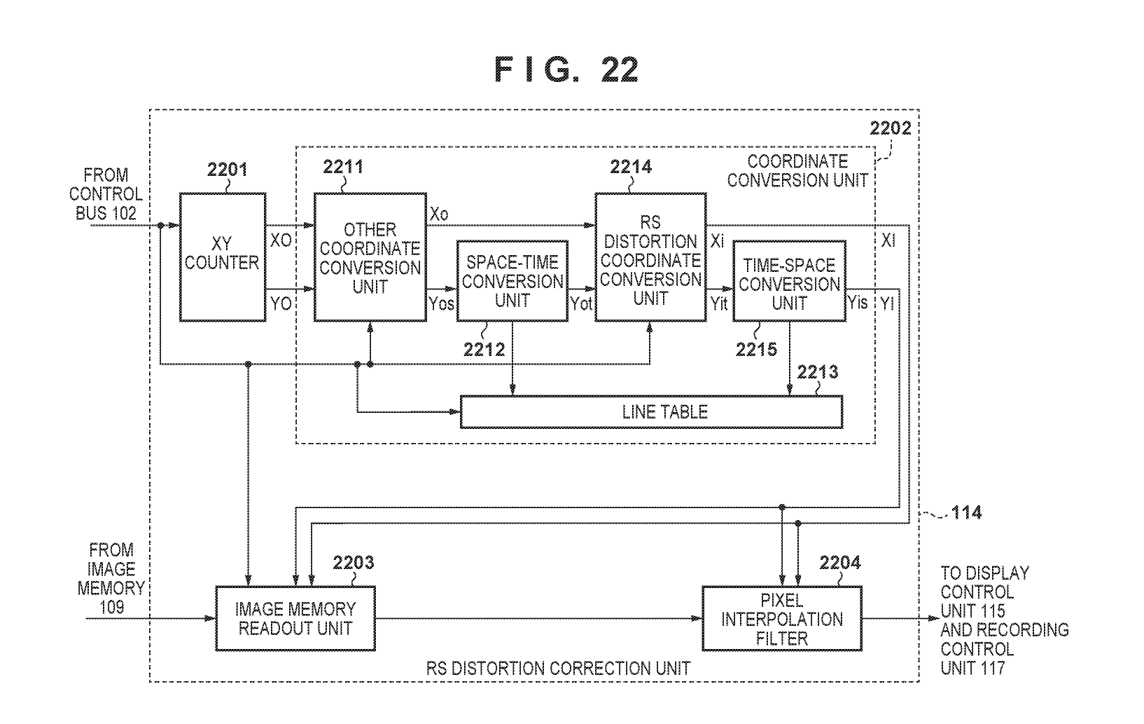

Details of the processing carried out by the RS distortion correction unit 114 will be described next using FIG. 22. FIG. 22 is a block diagram illustrating the internal configuration of the RS distortion correction unit 114 illustrated in FIG. 20. As described with reference to FIG. 20 too, various settings regarding RS distortion correction are received from the control microcomputer 101 via the control bus 102, the image data is read out from the image memory 109, the RS distortion correction is carried out thereon, and the corrected image data is output to the display control unit 115 and the recording control unit 117.

An XY counter 2201 outputs, for the image data output from the RS distortion correction unit 114, XO, indicating a pixel position in the horizontal direction, and YO, indicating a line position, while incrementing XO and YO so as to scan all the pixels. The size of the image data is set by the control microcomputer 101. XO is reset to 0 every time XO is incremented to the number of pixels in the horizontal direction, whereupon YO is incremented. Once YO has been incremented to the number of lines, a limiter is applied. An enable signal indicating whether the processing is available or unavailable is associated with the counter signals output from the XY counter 2201, and in the case where the limiter has been applied, the enable signal is output as “unavailable” until the next reset by the vertical synchronization signal. XO and YO are reset to 0 in response to a vertical synchronization signal supplied from the exterior. However, the source and distribution paths of the vertical synchronization signal are not illustrated in FIGS. 20 and 22.

A coordinate conversion unit 2202 carries out coordinate conversion on XO and YO output from the XY counter 2201 on the basis of setting details from the control microcomputer 101, and outputs XI and YI. XI and YI are readout positions of the image data stored in the image memory 109, relative to the pixel positions XO and YO in the image data output by the RS distortion correction unit 114. The enable signal is also associated with XI, YI, and a counter signal processed within the coordinate conversion unit 2202, and the processing of the blocks within the coordinate conversion unit 2202 is activated or stopped on the basis of the enable signal transmitted from the XY counter 2201. The internal configuration of the coordinate conversion unit 2202 will be described later.

An image memory readout unit 2203 reads out, from the image data stored in the image memory 109, pixel values at the readout position specified by XI and YI output from the coordinate conversion unit 2202 and a surrounding region thereof. An image data storage position in the image memory 109, an offset position for each line, and so on set by the control microcomputer 101 are used to obtain the readout position in the image memory 109. In addition to the data signals indicated in FIG. 22, address signals, request signals, readout enable signals, and so on, found in a typical memory interface, are exchanged with the image memory 109, but these are not illustrated here.

A pixel interpolation filter 2204 buffers the readout target region read out by the image memory readout unit 2203 in an internal memory, calculates pixel values of XI and YI output from the coordinate conversion unit 2202 using pixel values of the surrounding region using a pixel interpolation filter, and outputs those pixel values. Any interpolation method such as linear interpolation or bicubic interpolation may be used for the pixel interpolation filter.

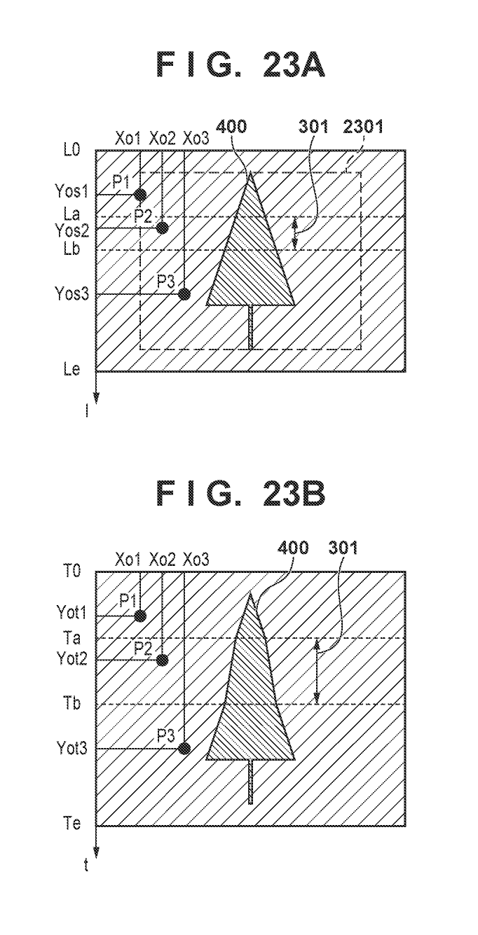

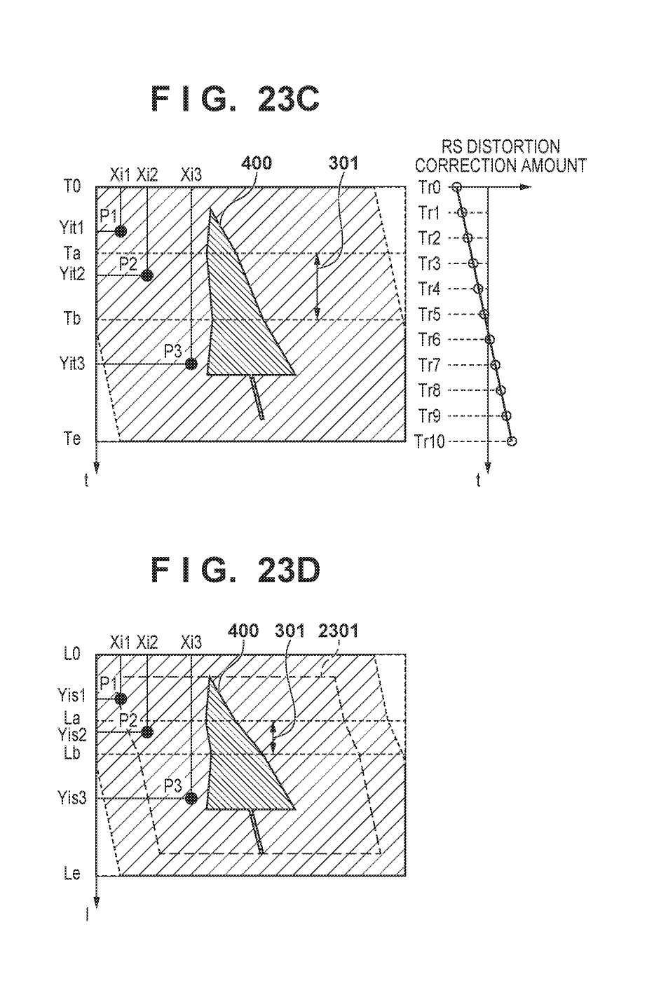

The internal configuration of the coordinate conversion unit 2202 illustrated in FIG. 22 will be described next with reference to FIGS. 23A to 23D as well. FIGS. 23A to 23D illustrate an example of how the counter signals output from the XY counter 2201 undergo coordinate conversion in the internal blocks within the coordinate conversion unit 2202, with respect to pixels P1, P2, and P3 in the image data output by the RS distortion correction unit 114.

Another coordinate conversion unit 2211 carries out coordinate conversion not used in the RS distortion correction. In order for the RS distortion correction unit 114 to carry out executable image processing by changing the readout positions of the image data stored in the image memory 109 at the same time as the RS distortion correction, coordinate conversion is carried out on the input counter signals XO and YO, and Xo and Yos are output as a result. Specifically, correction of distortion aberration caused by the imaging optical system 104, and correction of transitional shake, rotational shake, and pitch shake produced from frame to frame in the captured image data, are carried out on the basis of settings from the control microcomputer 101.

FIG. 23A is a diagram illustrating coordinates (Xo1,Yos1), (Xo2,Yos2), and (Xo3,Yos3) of the pixels P1, P2, and P3, output by the other coordinate conversion unit 2211. In FIG. 23A, the horizontal axis represents a pixel position in the horizontal direction, and the vertical axis represents the position of each line. The coordinate system used is the same as that in the subject image prior to the RS distortion, in the case where the effects of the coordinate conversion carried out by the other coordinate conversion unit 2211 are ignored. The RS distortion correction can be realized by converting the image data in which RS distortion has occurred into this coordinate system. A broken line 2301 in FIG. 23A indicates a range of image data output from the RS distortion correction unit 114. The output range 2301 is made smaller because a predetermined multiple is provided in order to ensure that the range read out through the RS distortion correction does not exceed the range of the image data stored in the image memory 109. Note that in the case where angle data greater than a predetermined amount is present, the control microcomputer 101 adjusts the RS distortion correction amount for all lines at a constant ratio so that the readout range of the RS distortion correction unit 114 does not exceed the range of the image data.

A space-time conversion unit 2212 converts the line position counter signal Yos from a spatial axis to a time axis and outputs Yot. Here, “spatial axis” is a coordinate axis indicating a position of that line in a space, such as the image capturing plane of the image sensor 107 or a display plane of the display unit 116. The “time axis” is a coordinate axis indicating a time for which charge accumulation, readout, or the like of that line is to be carried out in the image sensor 107. FIG. 23B is a diagram illustrating line positions Yot1, Yot2, and Yot3 of the pixels P1, P2, and P3, output by the space-time conversion unit 2212, and pixel positions Xo1, Xo2, and Xo3 in the horizontal direction, output by the other coordinate conversion unit 2211. In FIG. 23B, the horizontal axis represents a pixel position in the horizontal direction, and the vertical axis represents the charge accumulation timing of each line. The charge accumulation timing of each pixel is calculated so as to reflect the readout time being double for each line in the target region 301 for focus detection.

A line table 2213 holds a timing of charge accumulation for each line. The control microcomputer 101 calculates the charge accumulation timing for each line and sets those timings in the line table 2213 in consideration of the length of the readout time being double in each line in the target region 301 for focus detection. As the structure of the data stored in the line table 2213, for example, a charge accumulation timing shift amount is stored for each line using a case where the target region for focus detection is not present as a reference. In the example illustrated in FIG. 23A, the shift amount is 0 in L0 to La, the shift amount increments one at a time, from 1 to (Lb−La), in La+1 to Lb, and the shift amount becomes (Lb−La) in Lb to Le. Here, the unit of the shift amount is the time required to read out a single line in a non-target region for focus detection. The size of the shift amount data stored for each line is determined by how many lines maximum are provided in the target region for focus detection. If the maximum is 255 lines, for example, the size of the stored data is 8 bits per line. The configuration may be such that the process for calculating the shift amount of the charge accumulation timing for each line from the position of the target region for focus detection, and storing that shift amount in the line table 2213, is carried out within the RS distortion correction unit 114 rather than by the control microcomputer 101. Even if the line table 2213 is not provided as described here, another configuration may be employed as long as the spatial axis-time axis conversion can be realized within a desired amount of processing time. In the eighth embodiment, the space-time conversion unit 2212 converts the counter signal Yos in the spatial axis to the counter signal Yot in the time axis by referring to the line table 2213.

An RS distortion coordinate conversion unit 2214 carries out coordinate conversion used in the RS distortion correction. Discrete RS distortion correction amounts for Tr0 to Tr10, set by the control microcomputer 101, are interpolated, coordinate conversion is carried out on the input counter signals Xo and Yot, and Xi and Yit are output. FIG. 23C is a diagram illustrating coordinates (Xi1,Yit1), (Xi2,Yit2), and (Xi3,Yit3) of the pixels P1, P2, and P3, output by the RS distortion coordinate conversion unit 2214, along with set RS distortion correction amounts. In the drawing on the left side of FIG. 23C, the horizontal axis represents a pixel position in the horizontal direction, and the horizontal axis represents the charge accumulation timing of each line. The coordinate system used is the same as for the time axis image data read out from the image sensor 107.

A time-space conversion unit 2215 converts the counter signal Yit of the line position from the time axis to the spatial axis, and outputs Yis. FIG. 23D is a diagram illustrating line positions Yis1, Yis2, and Yis3 of the pixels P1, P2, and P3, output by the time-space conversion unit 2215, along with pixel positions Xi1, Xi2, and Xi3 in the horizontal direction, output by the RS distortion coordinate conversion unit 2214. In FIG. 23D, the horizontal axis represents a pixel position in the horizontal direction, and the vertical axis represents the position of each line. The coordinate system used is the same as for the image data stored in the image memory 109. FIG. 23D illustrates the overall range of the image data stored in the image memory 109, and a coordinate-converted output range 2301 is within the range of the image data. The RS distortion correction unit 114 realizes the RS distortion correction by reading out each pixel of the image data in this range. The time-space conversion unit 2215 converts the time axis counter signal Yit into the space axis counter signal Yis by referring to the line table 2213. To carry out this conversion, the line table 2213 holds a line position shift amount relative to the readout time that is opposite from the aforementioned readout time shift amount relative to the line position. The line table 2213 is described as having a simple configuration here in order to simplify the descriptions, but another configuration may be employed as long as the time axis-spatial axis conversion can be realized within a desired processing time.

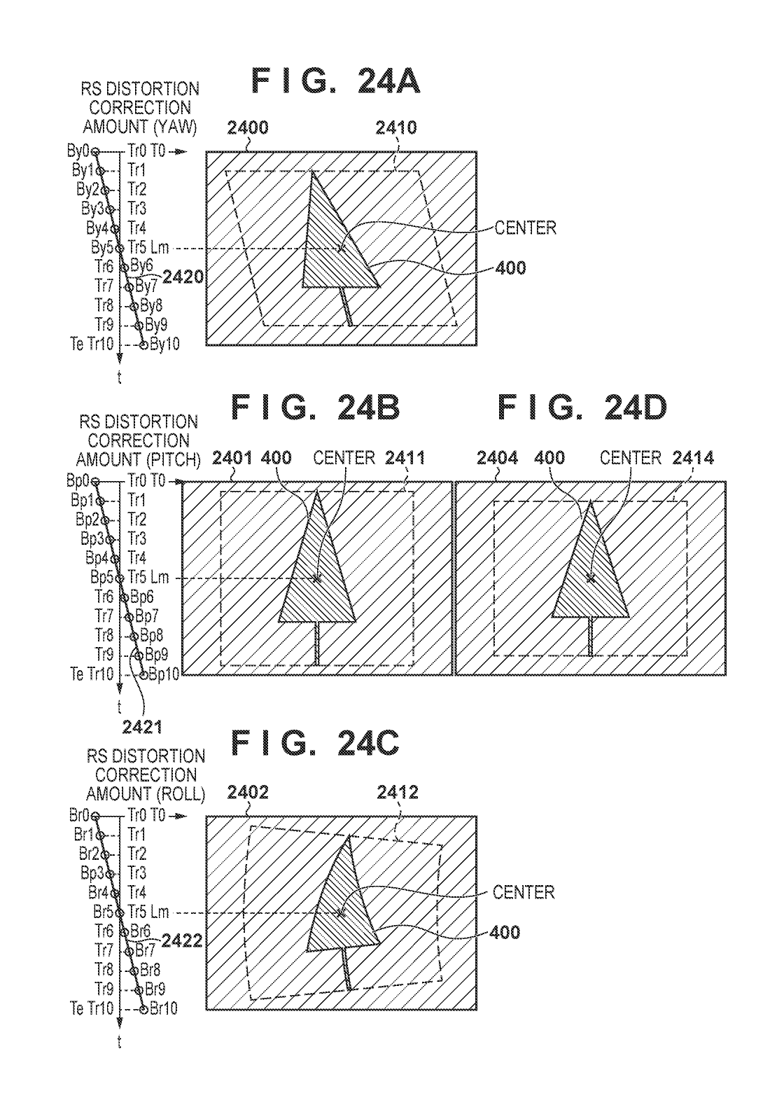

Next, typical processing in which RS distortion in the yaw direction, the pitch direction, and the roll direction is corrected through the coordinate conversion of the RS distortion coordinate conversion unit 2214 will be described using FIGS. 24A to 24D. FIGS. 24A, 24B, and 24C illustrate image data before RS distortion correction in the yaw direction, the pitch direction, and the roll direction, respectively, and FIG. 24D illustrates the corrected image data.

In FIG. 24A, reference numeral 2400 indicates the overall range of image data stored in the image memory 109. With the subject in the image data 2400, RS distortion has been produced by shake in the yaw direction imparted on the image capturing apparatus, and thus the subject is captured as distorted diagonally.

In the graph on the left side, the vertical axis represents each line in the image data, and the horizontal axis represents an RS distortion correction amount in the yaw direction. As described with reference to FIG. 21, Tr0 to Tr10 are positions, on the time axis, of target lines for which the control microcomputer 101 is to set the RS distortion correction amount in the RS distortion correction unit 114. By0 to By10 indicate yaw direction RS distortion correction amounts for Tr0 to Tr10. The RS distortion coordinate conversion unit 2214 calculates an RS distortion correction amount 2420 for each line in the image data 2400 from the discrete RS distortion correction amounts By0 to By10, using an interpolation method such as linear interpolation, and then carries out coordinate conversion for each of the pixel positions.

As a result of the coordinate conversion carried out by the RS distortion coordinate conversion unit 2214, the RS distortion correction unit 114 corrects the RS distortion in the horizontal direction by changing the readout start position in the horizontal direction for each line and outputting an output range 2410 from the image data 2400. An output range 2414 of image data 2404, indicated in FIG. 24D, is output as a result of this RS distortion correction. As described using FIG. 21, the correction is carried out so that the RS distortion correction amount is 0 at the intermediate line Lm, and thus the RS distortion correction amount is 0 at the intermediate line Lm, and the image data 2400 and the image data 2404 have the same center position.

In FIG. 24B, reference numeral 2401 indicates the overall range of image data stored in the image memory 109. With the subject in the image data 2401, RS distortion has been produced by shake in the pitch direction imparted on the image capturing apparatus, and thus the subject is captured as distorted so as to appear stretched in the vertical direction. Note that if the shake is in the opposite direction, the subject will be captured so as to appear compressed in the vertical direction.

In the graph on the left side, the vertical axis represents each line in the image data, and the horizontal axis represents a pitch direction RS distortion correction amount. Bp0 to Bp10 indicate pitch direction RS distortion correction amounts in Tr0 to Tr10. As described above, the RS distortion coordinate conversion unit 2214 calculates an RS distortion correction amount 2421 for each line in the image data 2401, and carries out coordinate conversion on each pixel position.

As a result of the coordinate conversion carried out by the RS distortion coordinate conversion unit 2214, the RS distortion correction unit 114 corrects the RS distortion in the vertical direction by shifting the readout positions in the vertical direction vertically for each line and outputting an output range 2411 from the image data 2401. The output range 2414 of image data 2404, indicated in FIG. 24D, is output as a result of this RS distortion correction. The RS distortion correction amount is 0 at the intermediate line Lm, and thus the center position is the same in both the image data 2401 and the image data 2404.

In FIG. 24C, reference numeral 2402 indicates the overall range of image data stored in the image memory 109. With the subject in the image data 2402, RS distortion has been produced by shake in the roll direction imparted on the image capturing apparatus, and thus the subject is captured as distorted into a fan shape.

In the graph on the left side, the vertical axis represents each line in the image data, and the horizontal axis represents a roll direction RS distortion correction amount. Br0 to Br10 indicate roll direction RS distortion correction amounts for Tr0 to Tr10. As described above, the RS distortion coordinate conversion unit 2214 calculates an RS distortion correction amount 2422 for each line in the image data 2402, and carries out coordinate conversion on each pixel position.

As a result of the coordinate conversion carried out by the RS distortion coordinate conversion unit 2214, the RS distortion correction unit 114 corrects the RS distortion in the roll direction by rotating the readout position for each line central to the center of the image and outputting an output range 2412 from the image data 2402. The output range 2414 of image data 2404, indicated in FIG. 24D, is output as a result of this RS distortion correction. The RS distortion correction amount is 0 at the intermediate line Lm, and thus the center position is the same in both the image data 2402 and the image data 2404.

RS distortion correction in the horizontal, vertical, and rotation direction have been described separately here. However, in reality, a combination of RS distortions caused by shake in the yaw, pitch, and roll directions will appear in a single piece of image data. By the RS distortion coordinate conversion unit 2214 carrying out the coordinate conversion with a combination of the horizontal, vertical, and rotation direction RS distortion correction amounts for the line positions in each pixel position, the RS distortion correction unit 114 can correct those instances of RS distortion all at once and output the corrected image data.

An operation sequence of the image capturing apparatus 100′ is almost the same as that described in the first embodiment with reference to FIG. 6, but differs in that in F[ ], the angle data obtainment carried out by the angle data generation unit 2013 (described later) is carried out in synchronization with the center of the charge accumulation period on the time axis, as well as in terms of the processing carried out in Ra[ ], Cr[ ], and Cs[ ]. Ra[ ], Cr[ ], and Cs[ ] will be described hereinafter.

Ra[ ] indicates a period in which the angle data generation unit 2013 generates the angle data. The angle data generation unit 2013 generates the angle data at a timing corresponding to a predetermined interval based on instructions from the control microcomputer 101, in synchronization with the center of the charge accumulation period of each line on the time axis, indicated by the dot-dash line for F[ ]. The timings Ts0 to Ts6 at equal intervals, described with reference to FIG. 21A, are provided in the period Ra[ ] in each frame, and the angle data AO to A6 is generated for F[ ] at each timing.

Cr[ ] indicates a period in which the control microcomputer 101 controls the RS distortion correction. In the RS distortion correction control, for example, a notification that the angle data generation unit 2013 has generated the angle data at Ra[n] is received, and the RS distortion correction amount to be set in the RS distortion correction unit 114 is calculated from the angle data at Cr[n]. The target lines for calculating the RS distortion correction amount are arranged at equal intervals on the time axis with respect to the image data read out from the image sensor 107, as indicated in FIG. 21, using the position of the target region for focus detection determined in the AF processing of Ce[n−2]. The result from Ce[n−2] is used instead of Ce[n] because in the control of the image sensor 107 (described later), the target region for focus detection of F[n+2] is set in Ce[n] using the result from Ce[n], and thus a phase difference equivalent to two frames is required. The calculated RS distortion correction amount is set in the RS distortion correction unit 114 along with the position of the target line. Additionally, in the RS distortion correction control, using the results of the AE processing and the AF processing of Ce[n], the timing at which the angle data is obtained in Ra[n+2] started after the next vertical synchronization signal Vs[n+1] is set for the angle data generation unit 2013.

Cs[ ] indicates a period in which the control microcomputer 101 controls the image sensor 107. For example, upon receiving a notification of the vertical blanking signal Vb[n], the charge accumulation start timing at F[n+2], where the charge accumulation after the next vertical synchronization signal Vs[n+1] is started, and the target region for focus detection, are set for the image sensor 107, using the results of the AE processing and the AF processing of Ce[n] at Cs[n].

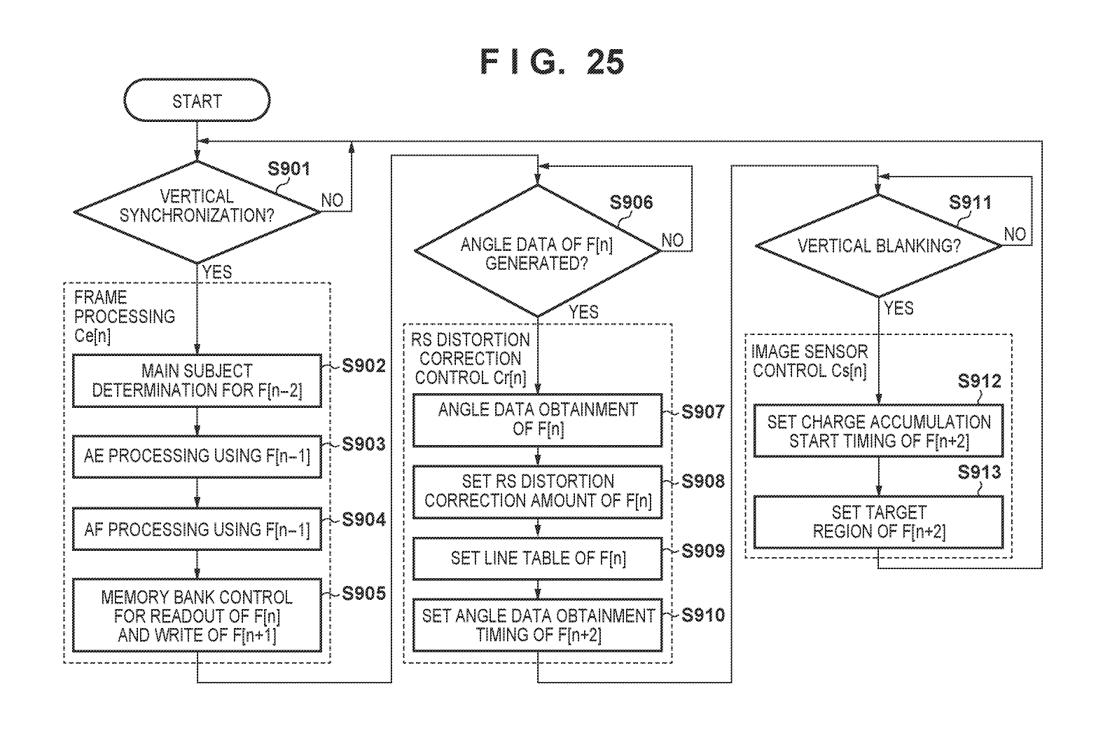

Next, details of the processing carried out by the control microcomputer 101 when the image capturing apparatus 100′ processes one frame of the image data at a time will be described using the flowchart in FIG. 25. This processing corresponds to the control periods Ce[ ], Cr[ ], and Cs[ ] of the control microcomputer 101, illustrated in FIG. 6.

In step S901, the control microcomputer 101 waits for the vertical synchronization signal, and the process moves to S902 upon the vertical synchronization signal being received. The processing from S902 to S905 is the frame processing of Ce[ ], indicated in FIG. 6. To clearly indicate the frames being processed in each step, the descriptions here will be given using Ce[n] as a reference.

In step S902, the above-described main subject determination is carried out using the results of the subject detection in F[n−2]. In S903, the above-described AE processing is carried out using the result of the exposure evaluation in F[n−1] and the result of the main subject determination in step S902. In step S904, the above-described AF processing is carried out using the subject defocus amount in F[n−1] and the result of the main subject determination in step S902.

In step S905, the above-described memory bank control is carried out for the write W[n+1] into the image memory 109 in F[n+1] and the readout R[n] from the image memory 109 in F[n].

In step S906, the control microcomputer 101 stands by for a notification that the generation of the angle data has ended, from the angle data generation unit 2013. If this is immediately after the processing of Ce[n], the control microcomputer 101 stands by for the processing to the corresponding Ra[n] to end.

The processing from step S907 to step S910 is the RS distortion correction control of Cr[ ], indicated in FIG. 6. The descriptions here will be given using Cr[n], corresponding to the above-described Ce[n] and Ra[n], as a reference.

In step S907, the angle data generation unit 2013 obtains the angle data of F[n] generated in Ra[n].

In step S908, the target lines for which the RS distortion correction amount is to be calculated are arranged using the position of the target region for focus detection determined in the AF processing of Ce[n−2] with respect to Cr[n], or in other words, from two frames previous. The RS distortion correction amount is calculated from the angle data obtained in step S907 for the arranged target lines, and is set in the RS distortion correction unit 114 along with the positions of the target lines.

In step S909, the shift amount of the charge accumulation timing for each line is calculated and set in the line table 2213 of the RS distortion correction unit 114, using the position of the target region for focus detection determined in the AF processing from two frames previous.

In step S910, the angle data obtainment timing is set for the angle data generation unit 2013 using the results of the AE processing and the AF processing from two frames previous.

In step S911, the control microcomputer 101 stands by for a notification of the vertical blanking signal, and moves the process to step S912 upon receiving the vertical blanking signal. The processing of S912 and S913 is the image sensor 107 control of Cs[ ], indicated in FIG. 6.

In step S912, the charge accumulation start timing of the image sensor 107 is set for F[n+2] using the results of the AE processing and the AF processing carried out immediately before. In step S913, the target region for focus detection of the image sensor 107 is set for F[n+2] using the result of the AF processing carried out immediately before, and the process then returns to step S901.

As described thus far, according to the eighth embodiment, rolling shutter distortion in captured image data can be properly corrected even if the length of the readout time differs from line to line of the image sensor.

The eighth embodiment describes an example in which the target region for focus detection is consolidated into a single location in the vertical direction in order to simplify the descriptions. However, the target region for focus detection may be distributed and arranged on a line-by-line basis, and the arrangement thereof need not be regular. In the case where the arrangement is irregular, the RS distortion correction amount calculated by the RS distortion correction unit 114 for each line will become more accurate as the granularity of the discrete RS distortion correction amounts set in the RS distortion correction unit 114 by the control microcomputer 101 become narrower. However, if differences between the readout times of the lines in the image sensor 107 are not significantly high relative to the shake amount, a sufficient correction effect can be obtained even if the granularity is set as described in the eighth embodiment.

### Ninth Embodiment

Next, a ninth embodiment of the present invention will be described. An image capturing apparatus according to the ninth embodiment differs from that in the eighth embodiment in that a plurality of readout modes for reading out the output signals from the image sensor 107 at high speeds are provided, and the RS distortion correction is carried out in accordance with a selected readout mode under the control of the control microcomputer 101. In the ninth embodiment, readout modes 0 to 3 described in the second embodiment with reference to FIGS. 9A to 9C are employed as the plurality of readout modes. Other points are the same as those described in the eighth embodiment, and thus only the differences will be described here.

In the ninth embodiment, the control microcomputer 101 controls the RS distortion correction in consideration of the time required for readout being double in the target region for focus detection than in other regions in mode 0, and being 4/3 times in modes 1 and 2. Specifically, the angle data generation timings Ts0 to Ts6 instructed to the angle data generation unit 2013, and the positions Tr0 to Tr10, on the time axis, of the target lines for setting the RS distortion correction amount set by the RS distortion correction unit 114, are calculated in accordance with the mode.

Meanwhile, the manner in which the shift amount of the charge accumulation timing for each line, stored in the line table 2213 of the RS distortion correction unit 114, is also changed in accordance with the mode. Specifically, in modes 1 and 2, the unit of the time required for readout in each line of the non-target region for focus detection is set to 3, and thus the shift amount for each line in the target region for focus detection is set to 1. In the example described here, the shift amount is 0 in L0 to La, the shift amount increments one at a time, from 1 to (Lb−La), in La+1 to Lb, and the shift amount becomes (Lb−La) in Lb to Le. The space-time conversion unit 2212 and the time-space conversion unit 2215 carry out the coordinate conversion on the counter signals of the line positions having multiplied the shift amounts from the line table 2213 by ⅓.

An example in which the data size of each line read out from the target region for subject detection in modes 1 and 2 is 4/3 times that of other regions has been described here for the sake of simplicity. However, the multiple need not be 4/3, and other multiples may be used instead. In other words, the size of the horizontal region may be provided at any desired ratio, the number of pixels added may be set to a different unit, and the number of lines that are thinned may be set to a different value. Additionally, to shorten the readout time of the a signal, the configuration may be such that an operation is carried out to reduce the bit accuracy of the a signal compared to the a/b combined signal. Additionally, the target region for focus detection may be distributed on a line-by-line basis.

### Tenth Embodiment

Next, a tenth embodiment of the present invention will be described. An image capturing apparatus 100′ according to the tenth embodiment differs from the eighth embodiment in that a limit is placed on the arrangement of the target region for focus detection to reduce the size of the line table in the RS distortion correction unit 114. Other points are the same as those described in the eighth embodiment, and thus only the differences will be described here.

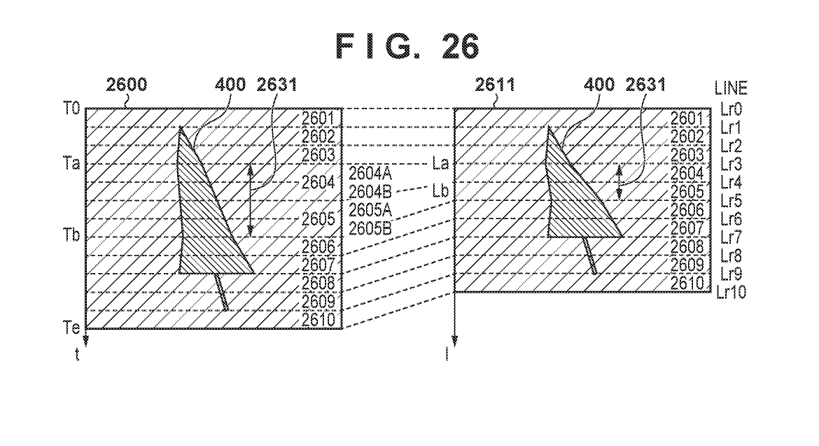

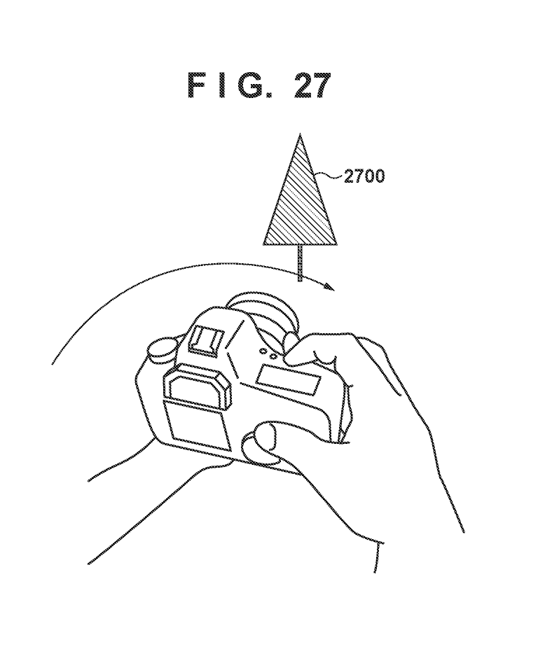

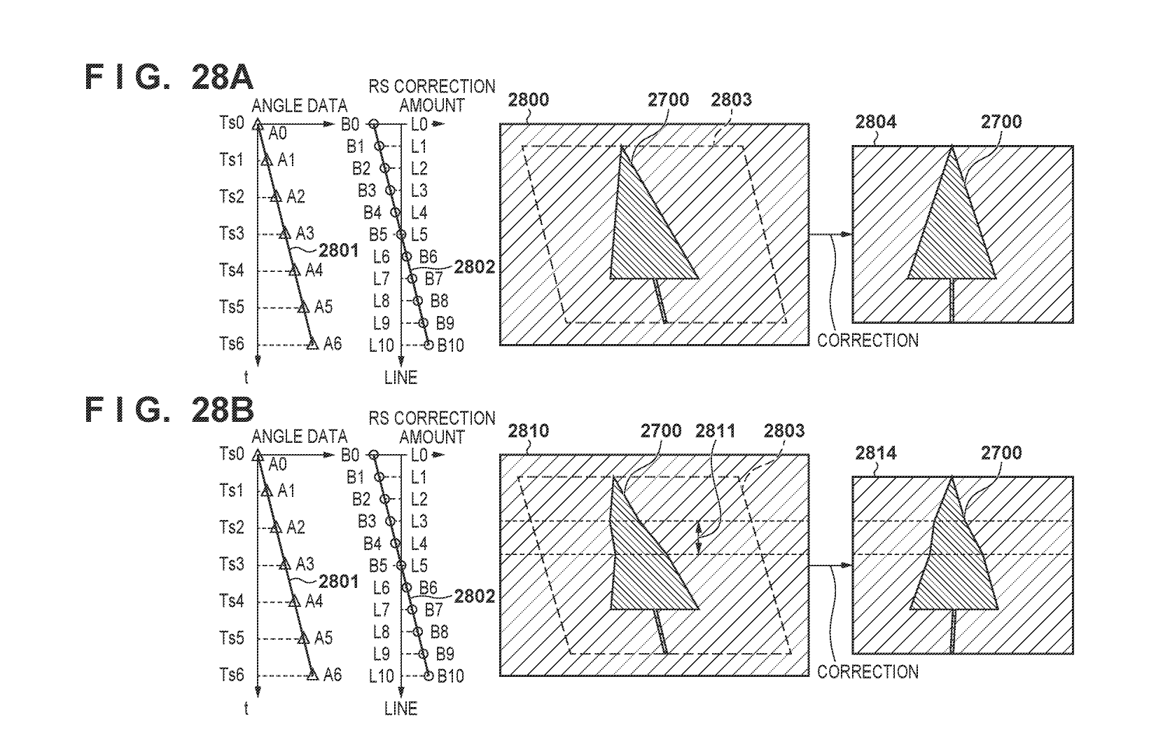

The arrangement of the target region for focus detection according to the tenth embodiment will be described using FIG. 26.

FIG. 26 illustrates an example of image data 2600 read out from the image sensor 107 and image data 2611 stored in the image memory 109 as a result of the signal processing unit 108 processing the image data 2600, with the captured subject 400. In the tenth embodiment, the control microcomputer 101 divides the image capturing plane of the image sensor 107 every 2^{N} lines in the vertical direction, and assigns the target region for subject detection by region obtained from this division. N is a natural number, and is a fixed value set in advance in accordance with the number of lines in the image data read out from the image sensor 107. For example, in the case where N=7, a division region is provided every 128 lines. In a division region serving as the target region for focus detection, it is assumed that focus detection is carried out for all of the lines, and that the readout time of each line is double. Here, a target region 2631 for focus detection in the image data 2600 read out from the image sensor 107 is assigned to division regions 2604 and 2605 among division regions 2601 to 2610 obtained from division into 10 parts. The readout time for each line in the division regions 2604 and 2605 is double that in the other regions. As such, the division regions 2604 and 2605 are illustrated at double the size in the time axis direction, and the way in which the subject is distorted is also different. In the image data 2611 stored in the image memory 109, the vertical direction lengths of the division regions 2604 and 2605, based on the number of lines, are the same as in the other regions, but the way in which the subject is distorted is different from the other regions.

By providing a limit on the arrangement of the target region for focus detection in this manner, the size of the line table 2213 of the RS distortion correction unit 114 can be reduced. Specifically, for a case where there are no focus detection regions whatsoever, how much of a shift amount is present for the charge accumulation timing at the top line of each division region is stored in the line table 2213 with the 2N number of lines taken as 1. For example, in the case illustrated in FIG. 26, the shift amount in the top line set in the line table 2213 is 0 for the division regions 2601 to 2603, 1 for the division regions 2604 and 2605, and 2 for the division regions 2606 to 2610. Additionally, a shift increase amount that increases with each line within each division region is stored in the line table 2213, assuming the length of the readout time for the non-target region for focus detection is 1. This is 1 in division regions serving as the target region for focus detection and 0 in other division regions, and thus the shift increase amount for each line is 0 in the division regions 2601 to 2603, 1 in the division regions 2604 and 2605, and 0 in the division regions 2606 to 2610.

By the space-time conversion unit 2212 dividing the value of the counter signal Yos at the input line position by 2^{N}, the number of the division region, for which the shift amount is stored in the line table 2213, and whether the shift increase amount for each line can be used, can be determined. For example, in the case where N=7 and a Yos of 1000 is input, INT(1000÷128)+1=8. Thus Yos can be coordinate-converted to Yot using the eighth division region 2608. Note that INT( ) is a function that discards numbers below the decimal point.

The value of the counter signal Yit at the input line position is also divided by 2^{N} and used by the time-space conversion unit 2215. However, the division regions 2604 and 2605 have double the size on the time axis, and thus the number of the division region, for which the shift amount is stored in the line table 2213, and whether the shift increase amount for each line, can be used, cannot be determined directly. For example, in the case where N=7 and the number of lines in the division regions 2604 and 2605 on the time axis is double, namely 256 lines, if Yit=1256, then INT(1256÷128)+1=10. However, it is expected that the division region 2608, rather than the division region 2610, will actually be used. As such, the division regions corresponding to the target region for focus detection are increased by two and stored in that form in the line table 2213 so as to include the shift amount of each division region, such that the value of the division region 2608 is stored for the tenth division region. For example, in the case of FIG. 26, the division region 2604 is taken as a division region 2604A and a division region 2604B, and the division region 2605 is taken as a division region 2605A and a division region 2605B. As such, a top line shift amount and line-by-line shift increase amount are stored for 12 division regions. The top line shift amount is 0 in the division regions 2601 to 2603 and 2604A, −0.5 in the division region 2604B, −1 in the division region 2605A, −1.5 in the division region 2605B, and −2 in the division regions 2606 to 2610. The line-by-line shift increase amount is 0 in the division regions 2601 to 2603, −0.5 in the division regions 2604A to 2605B, and 0 in the division regions 2606 to 2610. Also storing such time-based data makes it possible for the time-space conversion unit 2215 to coordinate-convert Yit into Yis with ease as well.

The first to tenth embodiments describe examples in which the target region (line) for focus detection is provided in one location in the vertical direction, in order to simplify the descriptions. However, a plurality of positions may be used as target regions. In this case, by setting each region in the image sensor 107 and the RS distortion correction amount computation unit 113, the focus detection can be carried out in a plurality of regions, and RS distortion correction amounts suited thereto can be calculated.

In the case where a plurality of regions are provided as target regions for focus detection to be set in the image sensor, the same effects can be achieved by setting those regions in the RS distortion correction amount computation unit 113 and finding the RS distortion correction amounts using those regions. Furthermore, although the RS distortion correction amount computation unit 113 is described as calculating the correction amount on the basis of the angular velocity obtained from the angular velocity sensor 112, the configuration is not limited thereto. For example, the correction amount may be calculated on the basis of a motion vector or a velocity vector calculated from the image, or calculated from a combination thereof.

Additionally, although the foregoing first to tenth embodiments describe a case where each unit pixel in the image sensor is constituted of sub-pixels a and b, the sub-pixel configuration may be different. For example, a configuration is conceivable in which each unit pixel includes four photodiodes, arranged in a square grid, for a single microlens, such that focus detection can be carried out in both the horizontal direction and the vertical direction. Here, in the target region for focus detection, the pixel signals of the individual photodiodes are read out. In this case, the readout time is 4 times in the target region for focus detection, but by the RS distortion correction amount computation unit calculating the RS distortion correction amount in consideration of the length of time required for the readout in each line, the same effects as those described before can be achieved.

Additionally, different readout modes may be used for the plurality of regions, and the setting details of those modes may be used to find the RS distortion correction amount even if the readout times differ from line to line.

### Other Embodiments

Note that the invention may be applied in a system constituted of multiple devices or in an apparatus constituted of a single device.

Embodiments of the invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-166008, filed on Aug. 26, 2016 which is hereby incorporated by reference herein in its entirety.

What is claimed is:

1. An image processing apparatus comprising:
an input unit that inputs an image signal from an image sensor, which accumulates a charge converted from received light of a subject image formed by an imaging optical system at a timing depending on a respective line, the image sensor being capable of carrying out first readout control, in which each line in a first region is read out at a first timing, and second readout control, in which each line in a second region different from the first region is read out at a second timing different from the first timing;
an acquisition unit that acquires a shake amount from a shake detection unit at the first timing and the second timing; and
a correction unit that corrects distortion in the image signal caused by the shake amount, the correction unit changing a correction amount used in the correction on the basis of a difference between the first timing and the second timing.

2. The image processing apparatus according to claim 1,
wherein the image sensor includes a plurality of photoelectric conversion units for a respective plurality of microlenses;
in the first readout control, charges accumulated in all of the plurality of photoelectric conversion units corresponding to each microlens are combined and read out; and
in the second readout control, readout is carried out such that image signals corresponding to charges accumulated in part of the plurality of photoelectric conversion units corresponding to each microlens and image signals corresponding to charges accumulated in the other part of the plurality of photoelectric conversion units corresponding to each mirolens can be obtained.

3. The image processing apparatus according to claim 1, wherein a controller assigns the second region by units of lines.

4. The image processing apparatus according to claim 3, wherein the controller assigns the second region by assigning lines and a partial range in a line direction.

5. The image processing apparatus according to claim 3, wherein the controller divides an image capturing plane of the image sensor into a plurality of division regions, each of the division regions including a plurality of lines, and assigns the second region by units of division regions.

6. The image processing apparatus according to claim 5, wherein the controller assigns a range in a line direction within the division regions containing the second region as the second region.

7. The image processing apparatus according to claim 5, wherein the acquisition unit acquires the shake amount at timing at which an image signal is read out from a line at a boundary of the division region.

8. The image processing apparatus according to claim 5, wherein a calculation unit finds the correction amount corresponding to a line at a boundary of the division region.

9. The image processing apparatus according to claim 8, wherein the calculation unit further finds the correction amount corresponding to a plurality of lines excluding a boundary of the division region included in the second region.

10. The image processing apparatus according to claim 2, wherein in the second region, by predetermined number of microlenses, charges accumulated in part of the plurality of photoelectric conversion units are added together and output.

11. The image processing apparatus according to claim 2, wherein in the second region, every predetermined number of microlenses, charges accumulated in part of the corresponding plurality of photoelectric conversion units are output.

12. The image processing apparatus according to claim 1, further comprising a calculation unit that finds the correction amount corresponding to a predetermined discrete plurality of lines and sets the correction amount in the correction unit,
wherein the correction unit carries out the correction by correcting readout positions of each of pixels of the image signal stored in a memory on the basis of the set correction amount and then reading out the image signal.

13. The image processing apparatus according to claim 12, wherein the calculation unit finds the correction amount at narrower intervals in the second region than in the first region.

14. The image processing apparatus according to claim 12, wherein the calculation unit finds the correction amount such that the correction amount is 0 in an intermediate line in an image capturing plane of the image sensor.

15. An image processing apparatus comprising:
an input unit that inputs an image signal from an image sensor, which accumulates a charge converted from received light of a subject image formed by an imaging optical system at a timing depending on a respective line, the image sensor being capable of carrying out first readout control, in which each line in a first region is read out in a predetermined first time, and second readout control, in which each line in a second region different from the first region is read out in a second time different from the first time;
a memory that stores the image signal acquired from the image sensor;
an acquisition unit that acquires a shake amount from a shake detection unit;
a controller that assigns the second region to the image sensor;
a calculation unit that finds, on the basis of the shake amount acquired by the acquisition unit, a distortion correction amount for correcting distortion in an image expressed by the image signal, the distortion being caused by shake while the image sensor accumulates a charge; and
a correction unit that corrects the distortion and outputs an image by correcting a readout position of the image signal recorded in the memory on the basis of the distortion correction amount and the position of the second region.

16. The image processing apparatus according to claim 15,
wherein the image sensor includes a plurality of photoelectric conversion units for a respective plurality of microlenses;
in the first readout control, charges accumulated in all of the plurality of photoelectric conversion units corresponding to each microlens are combined and read out; and
in the second readout control, readout is carried out such that image signals corresponding to charges accumulated in part of the plurality of photoelectric conversion units corresponding to each microlens and image signals corresponding to charges accumulated in the other part of the plurality of photoelectric conversion units corresponding to each microlens can be obtained.

17. The image processing apparatus according to claim 15, wherein the controller assigns the second region by assigning lines and a partial range in a line direction.

18. The image processing apparatus according to claim 16, wherein in the second region, by predetermined number of microlenses, charges accumulated in part of the plurality of photoelectric conversion units are added together and output.

19. The image processing apparatus according to claim 16, wherein in the second region, every predetermined number of microlenses, charges accumulated in part of the corresponding plurality of photoelectric conversion units are output.

20. The image processing apparatus according to claim 15, wherein the controller divides an image capturing plane of the image sensor into a plurality of division regions every 2^{N} number of lines, and assigns the second region by units of division regions.

21. The image processing apparatus according to claim 20, wherein on the basis of a setting made for each of the division regions, the correction unit obtains a pixel position in the image data in the memory by converting a position of a pixel in an output image to a time axis based on a timing at which the image sensor accumulates a charge, correcting the pixel position on the basis of the distortion correction amount, and converting the corrected pixel position from the time axis to a spatial axis based on a position stored in the memory, and then reads out the image data from the memory.

22. An image capturing apparatus comprising:
the image sensor; and
the image processing apparatus comprising:
an input unit that inputs an image signal from an image sensor, which accumulates a charge converted from received light of a subject image formed by an imaging optical system at a timing depending on a respective line, the image sensor being capable of carrying out first readout control, in which each line in a first region is read out at a first timing, and second readout control, in which each line in a second region different from the first region is read out at a second timing different from the first timing;
an acquisition unit that acquires a shake amount from a shake detection unit at the first timing and the second timing; and
a correction unit that corrects distortion in the image signal caused by the shake amount, the correction unit changing a correction amount used in the correction on the basis of a difference between the first timing and the second timing.

23. An image processing method comprising:
inputting an image signal from an image sensor, which accumulates a charge converted from received light of a subject image formed by an imaging optical system at a timing depending on a respective line, the image sensor being capable of carrying out control in which each line in a first region is read out in a predetermined first time, and control in which each line in a second region different from the first region is read out in a second time different from the first time;
storing the image signal acquired from the image sensor in a memory;
acquiring a shake amount from a shake detection unit;
assigning the second region to the image sensor;
finding, on the basis of the shake amount acquired in the step of acquiring, a position of the second region assigned in the step of assigning, and a ratio of the first time to the second time, a distortion correction amount for correcting distortion in an image expressed by the image signal, the distortion being caused by shake while the image sensor accumulates a charge, and changing the distortion in the image caused by a difference between the first time and the second time; and
correcting the image signal stored in the memory on the basis of the distortion correction amount.

24. An image processing method comprising:
inputting an image signal from an image sensor, which accumulates a charge converted from received light of a subject image formed by an imaging optical system at a timing depending on a respective line, the image sensor being capable of carrying out control in which each line in a first region is read out in a predetermined first time, and control in which each line in a second region different from the first region is read out in a second time different from the first time;
storing the image signal acquired from the image sensor in a memory;
acquiring a shake amount from a shake detection unit;
assigning the second region to the image sensor;
finding, on the basis of the acquired shake amount, a distortion correction amount for correcting distortion in an image expressed by the image signal, the distortion being caused by shake while the image sensor accumulates a charge; and
correcting the distortion and outputting an image by correcting a readout position of the image signal recorded in the memory on the basis of the distortion correction amount and the position of the second region.

25. A non-transitory computer-readable storage medium storing a program that causes a computer to function as the respective units of the image processing apparatus comprising:
an input unit that inputs an image signal from an image sensor, which accumulates a charge converted from received light of a subject image formed by an imaging optical system at a timing depending on a respective line, the image sensor being capable of carrying out first readout control, in which each line in a first region is read out at a first timing, and second readout control, in which each line in a second region different from the first region is read out at a second timing different from the first timing;
an acquisition unit that acquires a shake amount from a shake detection unit at the first timing and the second timing; and
a correction unit that corrects distortion in the image signal caused by the shake amount, the correction unit changing a correction amount used in the correction on the basis of a difference between the first timing and the second timing.

26. A non-transitory computer-readable storage medium storing a program that causes a computer to function as the respective units of the image processing apparatus comprising:
an input unit that inputs an image signal from an image sensor, which accumulates a charge converted from received light of a subject image formed by an imaging optical system at a timing depending on a respective line, the image sensor being capable of carrying out first readout control, in which each line in a first region is read out in a predetermined first time, and second readout control, in which each line in a second region different from the first region is read out in a second time different from the first time;
a memory that stores the image signal acquired from the image sensor;
an acquisition unit that acquires a shake amount from a shake detection unit;
a controller that assigns the second region to the image sensor;
a calculation unit that finds, on the basis of the shake amount acquired by the acquisition unit, a distortion correction amount for correcting distortion in an image expressed by the image signal, the distortion being caused by shake while the image sensor accumulates a charge; and
a correction unit that corrects the distortion and outputs an image by correcting a readout position of the image signal recorded in the memory on the basis of the distortion correction amount and the position of the second region.
